(19) United States
(12) Patent Application Publication
(10) Pub. No.: US 2025/0051167 A1
(43) Pub. Date: Feb. 13, 2025

(54) Carbon Electrode Material for Improving the Performance of Supercapacitors and Method of Making Carbon Electrode Material

(71) Applicant: United States Department of Energy, Washington, DC (US)

(72) Inventors: Christopher Matranga, Pittsburgh, PA (US); Congjun Wang, Bethel Park, PA (US); Viet Hung Pham, Pittsburgh, PA (US); Jennifer Weidman, South Park, PA (US); Yuan Gao, Pittsburgh, PA (US)

(21) Appl. No.: 18/780,939

(22) Filed: Jul. 23, 2024

Related U.S. Application Data
(60) Provisional application No. 63/531,695, filed on Aug. 9, 2023.

(51) Int. Cl. C01B 32/184; B01J 27/232; B01J 27/28; H01G 11/34; H01G 11/86

(52) U.S. Cl. CPC C01B 32/184; B01J 27/232; B01J 27/28; H01G 11/34; H01G 11/86; C01B 2204/22; C01B 2204/32; C01P 2002/72; C01P 2002/82; C01P 2002/85; C01P 2004/03; C01P 2004/04; C01P 2006/12; C01P 2006/14; C01P 2006/17; C01P 2006/40

(57) ABSTRACT

One or more embodiments relate to a method for making carbon electrode material (CEM) having the steps: dispersing a carbon feedstock within a catalyst, thereby forming a mixture, wherein the catalyst is made up of particles; melting the carbon feedstock that is dispersed within the catalyst, thereby liquifying the carbon feedstock that coats catalyst particles and infiltrates spaces between the catalyst particles; carbonizing the melted carbon feedstock, thereby forming an interconnected 3D network of carbon nanosheets; converting the carbon nanosheets into graphene nanosheets; washing the graphene nanosheets, thereby forming the CEM; recovering and regenerating the catalyst. Further embodiments relate to repeating the method using recovered and regenerated catalyst.

### CROSS-REFERENCE TO RELATED APPLICATIONS

This Utility patent application claims priority benefit as a U.S. Non-Provisional of U.S. Provisional Patent Application Ser. No. 63/531,695, filed on Aug. 9, 2023, currently pending, the entirety of which is incorporated by reference herein.

### STATEMENT OF GOVERNMENT SUPPORT

The United States Government has rights in this invention pursuant to the employer-employee relationship of the Government to the inventors as U.S. Department of Energy employees and site-support contractors at the National Energy Technology Laboratory.

### FIELD OF THE INVENTION

Embodiments relate to carbon electrode materials (CEM), supercapacitors using CEM, and methods for making CEM.

### BACKGROUND

The growth of renewable energy has accelerated in recent years, in part, due to the decreasing cost of renewable energy sources and the global drive to decarbonize the energy economy. A key technology for addressing the intermittent and distributed nature of renewables is the development of efficient and reliable energy storage systems that can reduce curtailment, match electricity demand with grid capacity, and improve grid performance and reliability.

Supercapacitors, also called electrochemical capacitors, have attracted attention for grid-scale applications due to their high power density, reasonable energy densities, fast charge/discharge rates, low cost and ultralong cycle life. These devices bridge a gap between conventional capacitors and traditional batteries by storing more energy than capacitors and possessing higher power densities than batteries. Ideal supercapacitor electrode materials must have a high specific surface area, a pore size distribution that allows electrolyte ions to diffuse into accessible pores and form an electrochemical double layer (EDL), and good electrical conductivity for electron transfer.

Graphene is one of the most promising supercapacitor electrode materials because of its large surface area, high electrical conductivity, good chemical stability, and excellent mechanical strength. Its theoretical specific capacitance is ˜550 F g⁻¹ which is higher than all other carbon-based materials. One challenge with using graphene in practical supercapacitors is that fully exfoliated graphene sheets restack, and form aggregated graphite-like powders or films due to strong sheet-to-sheet van der Waals interactions, which decreases surface area and reduces ion diffusion rates, resulting in unsatisfactory capacitances and poor rate performance. One way to address this challenge is to construct the two-dimensional (2D) graphene sheets into a well-organized and interconnected, porous, 3D structure that prevents sheet restacking and preserves the electrical properties while enabling a large accessible internal surface area, efficient mass transport, and high electron conduction.

Several fabrication techniques have been reported for 3D graphene (3DG) including self-assembly and reduction of graphene oxide (GO), chemical vapor deposition of gaseous hydrocarbons on 3D structured substrates, on-site polymerization (OSP) of nongaseous hydrocarbons and chemical reduction of inorganic carbon compounds (CO₂, CO or CS₂) with alkali, alkali oxide and alkaline earth metals. All these methods are promising, but their use for practical supercapacitors is limited by the complexity of the procedure, cost and/or availability of feedstocks, mass yield of carbon product, and/or the quality of the 3D graphene produced.

A need in the art exists for graphene materials suitable for use in supercapacitors as well as methods to generate those materials, wherein the method is straightforward, uses cheap, abundant feedstock, and wherein reagents can be recycled.

### SUMMARY

Embodiments of the invention provides a method of making carbon electrode materials (CEM) that uses an inexpensive and abundant carbon feedstock, coal tar pitch (CTP), along with a potassium carbonate (K₂CO₃) catalyst in a simple, tube-furnace based process to make microscopic 3D graphenes with carbon mass yields as high as ˜37%. The quality of these 3D graphenes is indicated by Raman I_{D}/I_{G} ratios as low as 0.15 and the highest specific surface area reported for this material, yet, at 2113 m² g⁻¹. The K₂CO₃ catalyst was recycled at a mass recovery rate of 95% which was demonstrated for 10 full cycles with the quality of 3D graphene retained after each cycle. In various embodiments, the invented CEM material has outstanding electrochemical capacitive properties with a gravimetric specific capacitance of 182.6 F g⁻¹ at a current density of 1.0 A g⁻¹. This is unique because it is achieved at a mass loading of 30 mg cm⁻², which is 3 times higher than current commercial requirements for practical supercapacitor devices, resulting in ultra-high areal capacitance of 5.48 F cm⁻². These capacitive properties are among the highest, if not the highest, ever reported for graphene-based supercapacitor devices.

Embodiments overcome a long-standing challenge for fabricating practical supercapacitor electrodes which involves balancing two conflicting characteristics: high porosity and high material density. This challenge is addressed by embodiments of the invention by producing an electrically conductive 3D graphene possessing a pore structure that does not collapse under harsh compression giving it both high porosity and reasonable packing density. This allows for the high electron and ion transport rates needed to achieve outstanding electrocapacitive properties at ultrahigh mass loadings. Achieving these properties at ultrahigh mass loading overcomes the dilution of gravimetric energy and power densities that occurs in practical supercapacitor devices from the additional weight of current collectors, separators, electrolyte, binder, connectors, and packaging. As such, the invented synthesis method allows for the inexpensive production of electrodes and opens new opportunities for using graphene-based materials more broadly in practical supercapacitor devices.

The invention provides a carbon electrode material (CEM) comprising: a hierarchical, interconnected, 3D network of thin, crumpled, graphene sheets, wherein the graphene sheets comprise irregularly shaped, micro-, meso- and macro-scale pore structures, wherein the CEM comprises a BET SSA between approximately 1400 m² g⁻¹ and approximately 2200 m² g⁻¹, and wherein the CEM comprises a Raman I_{D}/I_{G} intensity ratio between approximately 0.05 to approximately 1.2.

The invention also provides a supercapacitor comprising: a first electrode, a second electrode, a porous separator positioned between the first and second electrodes, and an electrolyte in electronic and physical contact with the first and second electrodes and the porous separator, wherein at least one of the first and second electrodes comprise a carbon electrode material (CEM), the CEM comprising: a hierarchical, interconnected, 3D network of thin, crumpled, graphene sheets, wherein the graphene sheets comprise irregularly shaped, micro-, meso- and macro-scale pore structures, wherein the CEM comprises a BET SSA between approximately 1000 m² g⁻¹ and approximately 2200 m² g⁻¹, and wherein the CEM comprises a Raman I_{D}/I_{G} intensity ratio between approximately 0.05 to approximately 1.2.

The invention still further provides a method for making carbon electrode material (CEM) comprising: dispersing a carbon feedstock within a catalyst, thereby forming a mixture, wherein the catalyst comprises particles; melting the carbon feedstock that is dispersed within the catalyst, thereby liquifying the carbon feedstock that coats catalyst particles and infiltrates spaces between said catalyst particles; carbonizing the melted carbon feedstock, thereby forming an interconnected 3D network of carbon nanosheets; converting the carbon nanosheets into graphene nanosheets; washing the graphene nanosheets, thereby forming the CEM; and recovering and regenerating the catalyst.

### BRIEF DESCRIPTION OF THE DRAWINGS

The invention together with the above and other objects and advantages will be best understood from the following detailed description of the preferred embodiment of the invention shown in the accompanying drawings, wherein:

FIG. 1 is a flowchart for a method of making carbon electrode materials, in accordance with the features of the present invention;

FIG. 2A is an SEM image of carbon nanosheets made according to the invented method to produce carbon electrode materials, in accordance with the features of the present invention;

FIG. 2B in an SEM image of carbon nanosheets made according to the invented method to produce carbon electrode materials, in accordance with the features of the present invention;

FIG. 2C is a Raman spectra of carbon nanosheets made according to the invented method to produce carbon electrode materials, in accordance with the features of the present invention;

FIGS. 3A-3D are SEM images of an exemplary embodiment of the invented CEM with the FIG. 3A showing an SEM image of an exemplary embodiment of the invented CEM made using a CTP:K₂CO₃ mass ratio of 1:2, FIG. 3B showing an SEM image of an exemplary embodiment of the invented CEM made using a CTP:K₂CO₃ mass ratio of 1:5, FIG. 3C showing an SEM image of an exemplary embodiment of the invented CEM made using a CTP:K₂CO₃ mass ratio of 1:10, and FIG. 3D showing an SEM image of an exemplary embodiment of the invented CEM made using a CTP:K₂CO₃ mass ratio of 1:20, in accordance with the features of the present invention;

FIGS. 4A-4C are SEM images of exemplary embodiments of the invented CEM, in accordance with the features of the present invention;

FIGS. 4D-4I are TEM images of exemplary embodiments of the invented CEM, in accordance with the features of the present invention;

FIG. 5A is an SEM image of an exemplary embodiment of the invented CEM, in accordance with the features of the present invention;

FIG. 5B is a Raman spectrum of an exemplary embodiment of the invented CEM, in accordance with the features of the present invention;

FIG. 5C is an N₂ absorption-desorption isotherm of an exemplary embodiment of the invented CEM, in accordance with the features of the present invention;

FIG. 6A are Raman spectra of exemplary embodiments of the invented CEM, in accordance with the features of the present invention;

FIG. 6B are survey XPS spectra of exemplary embodiments of the invented CEM, in accordance with the features of the present invention;

FIG. 6C is a deconvoluted C1s XPS spectrum of an exemplary embodiment of the invented CEM, in accordance with the features of the present invention;

FIG. 6D are XRD patterns of exemplary embodiments of the invented CEM, in accordance with the features of the present invention;

FIG. 6E are N2 adsorption-desorption isotherms of exemplary embodiments of the invented CEM, in accordance with the features of the present invention;

FIG. 6F is a comparison of BET SSA and Raman I_{D}/I_{G} of embodiments of the invented CEM with other graphenes, in accordance with the features of the present invention

FIG. 7 is a Raman spectrum of commercial graphite, in accordance with the features of the present invention;

FIGS. 8A and 8B are C1s XPS spectra of exemplary embodiments of the invented CEM, in accordance with the features of the present invention;

FIG. 9 is a QSDT pore size distribution of exemplary embodiments of the invented CEM, in accordance with the features of the present invention;

FIG. 10A is a Cross-section SEM image of an electrode made with an exemplary embodiment of the invented CEM, where FIGS. 10B and 10C are SEM images of increased magnification of the image shown in FIG. 10A, in accordance with the features of the present invention;

FIG. 10D shows N₂ isotherms of electrodes made with exemplary embodiments of the invented CEM, in accordance with the features of the present invention;

FIG. 10E shows a pore size distribution of electrodes made with exemplary embodiments of the invented CEM, in accordance with the features of the present invention;

FIG. 11A is a cross-sectional SEM image of an electrode with a mass loading of 5.0 mg cm⁻² of an exemplary embodiment of the invented CEM, in accordance with the features of the present invention;

FIG. 11B is a cross-sectional SEM image of an electrode with a mass loading of 10.0 mg cm⁻² of an exemplary embodiment of the invented CEM, in accordance with the features of the present invention;

FIG. 11C is a cross-sectional SEM image of an electrode with a mass loading of 30.0 mg cm⁻² of an exemplary embodiment of the invented CEM, in accordance with the features of the present invention;

FIGS. 12A-12F are plots showing the electrocapacitive properties of supercapacitors using CEM electrodes with mass loading of 20 mg cm⁻², with FIG. 12A showing a cyclic voltammetry plot at a scan rate of 25 mV s⁻¹, FIG. 12B showing galvanostatic charge-discharge curves at current density of 1.0 A g⁻¹, FIG. 12C showing Nyquist plots with the inset of FIG. 12C showing a zoom-in on a portion of the plots with a scale of 0.0 to 2.0 ohms, FIG. 12D showing a plot of gravimetric specific capacitance, FIG. 12E showing Ragone plots, and FIG. 12F showing a plot cycling stability at current density of 4.0 A g⁻¹, in accordance with the features of the present invention;

FIGS. 13A-13H show the electrochemical capacitive properties of supercapacitors made with an exemplary embodiment of the invented CEM with different mass loadings using 6M KOH electrolyte with FIG. 13A showing a plot of cyclic voltammetry at scan rate of 25 mV s⁻¹, FIG. 13B showing galvanostatic charge-discharge curves at current density of 1.0 A g⁻¹, FIG. 13C showing Nyquist plots, with the inset of FIG. 13C showing a zoom-in on a portion of the plots with a scale of 0.0 to 1.6 ohms, FIG. 13D showing plots of gravimetric rate performance, FIG. 13E showing plots of specific areal capacitances as a function of electrode areal mass loading, FIG. 13F showing a plot of specific areal capacitances of an embodiment of the invented CEM and other high areal mass loading (beyond 10.0 mg cm⁻²) carbon electrode material at a current density of 1.0 A g⁻¹, FIG. 13G showing a Ragone plot, and FIG. 13H showing a plot of cyclic stability at a current density of 4.0 A g⁻¹, in accordance with the features of the present invention;

FIGS. 14A-14C show electrochemical capacitive properties of supercapacitors using electrodes with an exemplary embodiment of the invented CEP vs. benchmark commercial Kuraray YP-50F supercapacitors with mass loading of 20 mg cm⁻², with FIG. 14A showing a plot of a cyclic voltammetry at scan rate of 25 mV s⁻¹, FIG. 14B showing a plot of galvanostatic charge-discharge curves at current density of 1.0 A g⁻¹, and FIG. 14C showing a plot of Gravimetric specific capacitance as function of current density, in accordance with the features of the present invention;

FIG. 15A shows a cyclic voltammetry plot for a supercapacitor using an exemplary embodiment of the invented CEM, in accordance with the features of the present invention;

FIG. 15B shows galvanostatic charge discharge curves for a supercapacitor using an exemplary embodiment of the invented CEM with mass loading of 20 mg cm⁻², in accordance with the features of the present invention;

FIG. 15C shows a plot of volumetric specific capacitance for a supercapacitor using an exemplary embodiment of the invented CEM, in accordance with the features of the present invention;

FIG. 15D shows a Areal Ragone Plot for a supercapacitor using an exemplary embodiment of the invented CEM, in accordance with the features of the present invention;

FIG. 15E shows a plot of Coulombic efficiency for a supercapacitor using an exemplary embodiment of the invented CEM, in accordance with the features of the present invention;

FIG. 15F shows a Nyquist plot for a supercapacitor using an exemplary embodiment of the invented CEM with different mass loadings, in accordance with the features of the present invention;

FIGS. 16A-16D are SEM images of the invented CEM generated using recycled K₂CO₃, in accordance with the features of the present invention;

FIG. 16E are Raman spectra of the invented CEM generated using recycled K₂CO₃, in accordance with the features of the present invention;

FIG. 16F shows N2 isotherms of the invented CEM generated using recycled K₂CO₃, in accordance with the features of the present invention;

FIGS. 17A-17E show plots relating to electrochemical capacitive properties of supercapacitors using exemplary embodiments of the invented CEM with a mass loading of 10 mg cm⁻², with FIG. 17A showing a cyclic voltammetry plot at scan rate of 25 mV s 1, FIG. 17B showing galvanostatic charge discharge curves at a current density of 1.0 A g⁻¹, FIG. 17C showing Nyquist plots, with the inset of FIG. 17C showing a zoom-in on a portion of the plots with a scale of 0.0 to 1.0 ohms, FIG. 17D showing plots of gravimetric rate performance, and FIG. 17E showing plots of cyclic stability at a current density of 4.0 A g⁻¹, in accordance with the features of the present invention;

FIGS. 18A and 18B are SEM images of graphitic porous carbons (GPCs) synthesized from bituminous coal char (GPC-BCC), in accordance with the features of the present invention;

FIG. 18C is a Raman spectra of GPC-BCC, in accordance with the features of the present invention;

FIGS. 18D and 18E are SEM images of GPCs synthesized from spent coffee ground char (GPC-SCGC0, in accordance with the features of the present invention;

FIG. 18F is a Raman spectra of GPC-SCGC, in accordance with the features of the present invention;

FIG. 19A is an SEM image of petroleum pitch derived 3D graphene, in accordance with the features of the present invention;

FIG. 19B is a Raman spectrum of petroleum pitch derived 3D graphene, in accordance with the features of the present invention; and

FIG. 19C is N₂ adsorption-desorption isotherms of petroleum pitch derived 3D graphene, in accordance with the features of the present invention.

### DETAILED DESCRIPTION

The foregoing summary, as well as the following detailed description of certain embodiments of the present invention, will be better understood when read in conjunction with the appended drawings.

As used herein, “BET SSA” refers to a surface area calculated according to the Brunauer-Emmett-Teller method.

If not otherwise specified, “state of the art” refers to the active carbon product YP-50F made by Kuraray Co., Ltd. of Tokyo Japan.

As used herein, “3DG” followed by a dash and a number refers to CEM made using a particular graphehnization temperature in the invented method described below in the converting step 18. For example, 3DG-900 is a CEM made using a graphenization temperature of 900° C.

An embodiment of the present invention provides a carbon electrode material (CEM) suitable for use in capacitors and other electronic components. The invented CEM has superior properties to state of the art carbon electrode materials that provide capacitors with superior properties to those found in the prior art.

TABLE 1
Material Properties Invented CEM vs. State of the Art

| | Surface | Pore | Pore | | | | Electrical |
|---|---|---|---|---|---|---|---|
| | Area | Volume | Size | I_{D}/I_{G} | I_{2D}/I_{G} | Atomic | Conductivity |
| Material | (m²/g) | (cm³/g) | Distribution | Ratio | Ratio | C/O | (S/m) |
| Invented | 2113 | 1.8 | Hierarchical | 0.59 | 0.55 | 46.6 | 1295 |
| CEM | | | Pore Structure | | | | |
| Commercial SOTA | 1700 | 0.8 | Microporous | ~1.0 | <0.1 | 16.8 | <50 |
| (Activated Carbon: | | | structure | | | | |
| Kuraray YP 50F) | | | | | | | |

In an embodiment, the invented CEM comprises a hierarchical, interconnected, 3D network of thin, crumpled, graphene sheets between approximately 1 and approximately 20 layers, wherein the graphene sheets comprise irregularly shaped, macro-, meso-, and micro-scale pore structures with sizes ranging from a few microns down to tens of nanometers.

A salient feature of the invented CEM is that it comprises a high specific surface area. In an embodiment, the invented CEM comprises a specific surface area more than 24% greater than state of the art CEM material. In an exemplary embodiment, the invented CEM has a specific surface area between approximately 1000 m² g⁻¹ and approximately 2800 m² g⁻¹, preferably between approximately 1400 m² g⁻¹ and approximately 2200 m² g⁻¹, and typically between approximately 1800 m² g⁻¹ and approximately 2100 m² g⁻¹ In such embodiments, the invented CEM comprises a total pore volume between approximately 1.0 cm³ g⁻¹ and approximately 3.0 cm³ g⁻¹, preferably between approximately 1.5 cm³ g⁻¹ and approximately 2.5 cm³ g⁻¹, and typically between approximately 1.8 cm³ g⁻¹ and approximately 2.2 cm³ g⁻¹. The high specific surface area of the invented CEM is surprising and unexpected considering that the CEM also comprises a high degree of crystallinity as discussed below.

An important feature of the invented CEM is the number of layers of graphene comprising the CEM. In an embodiment, the graphene sheets have between approximately 1 and approximately 20 layers.

Yet another salient feature of the invented CEM is that it comprises irregularly shaped hierarchal micro-, meso-, and macro-pore networks, wherein the pore networks pores have sizes that are superior to those of the prior art. In an embodiment, the CEM comprise pore networks having sizes (diameters) between approximately 0.5 nm and approximately 500 μm, preferably between approximately 0.5 nm and approximately 200 nm, and typically between, approximately 0.7 nm and approximately 100 nm.

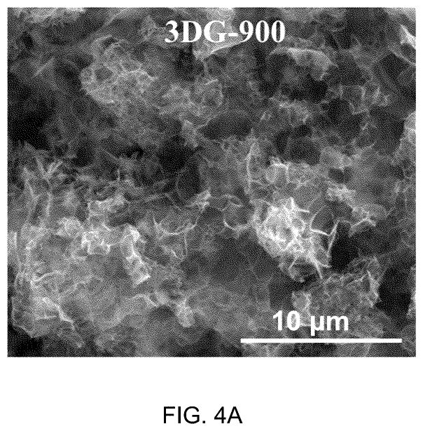

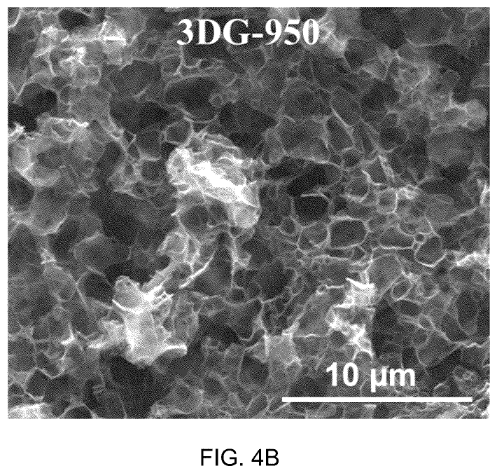

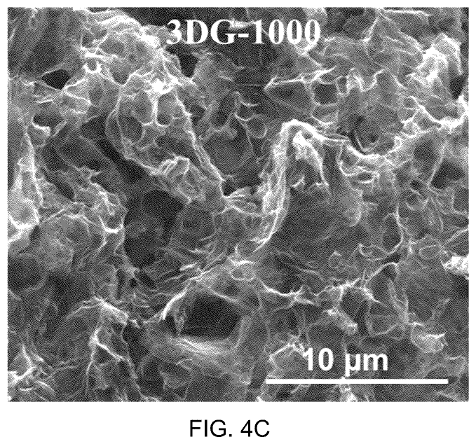

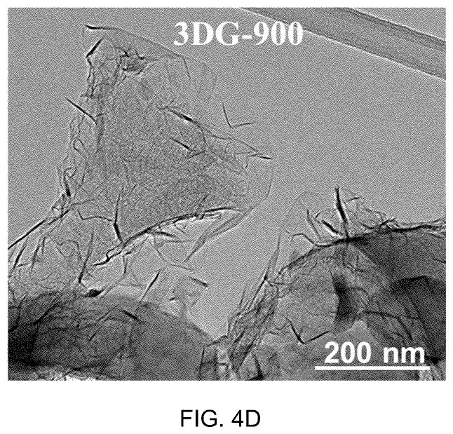

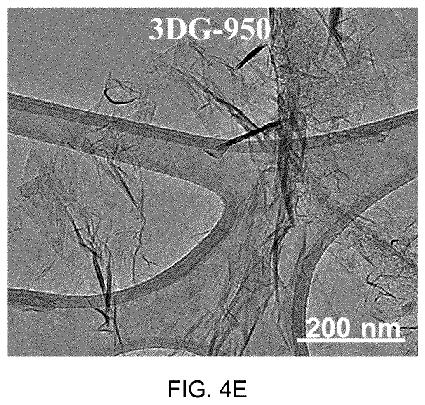

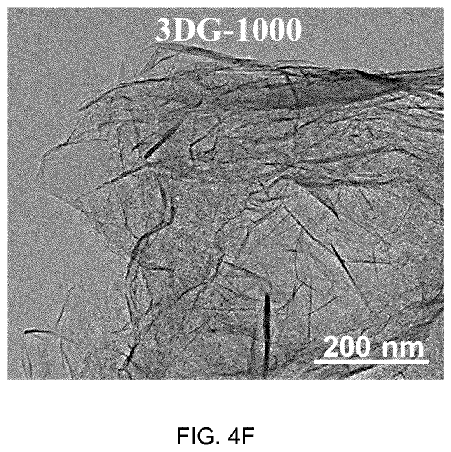

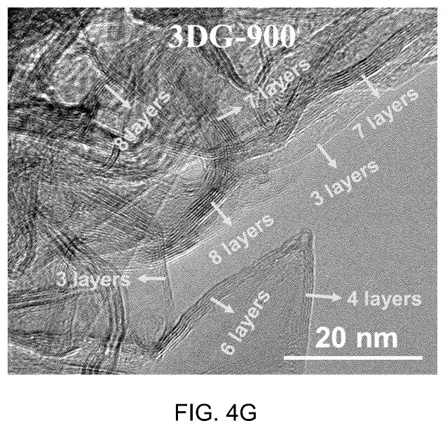

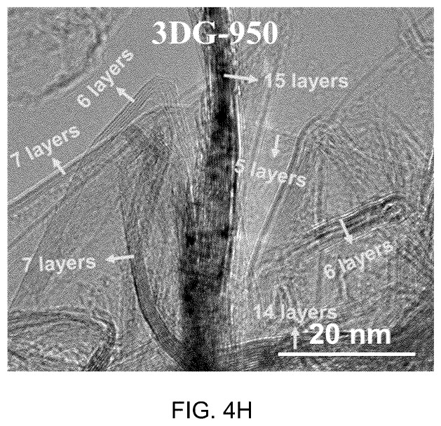

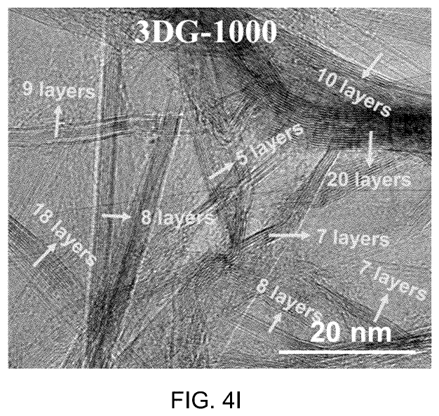

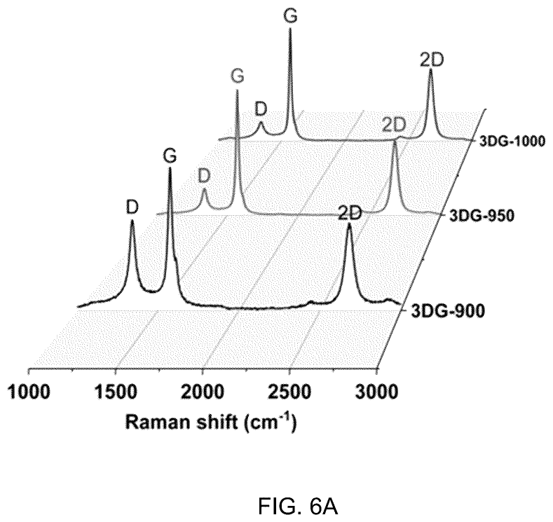

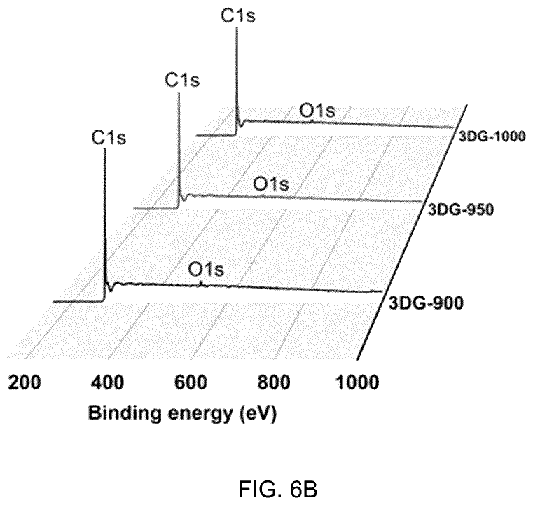

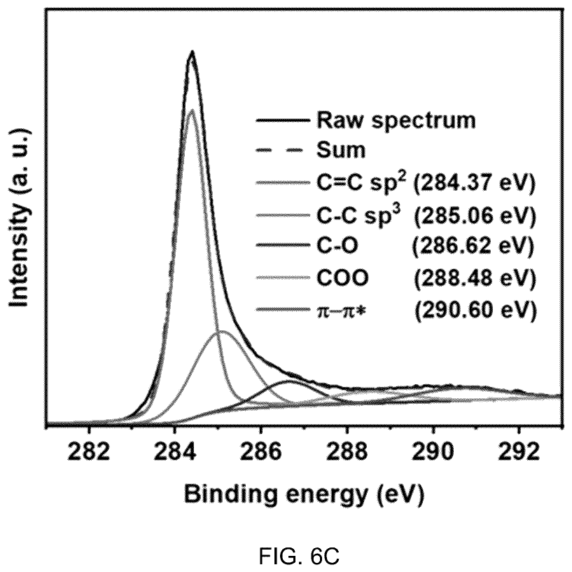

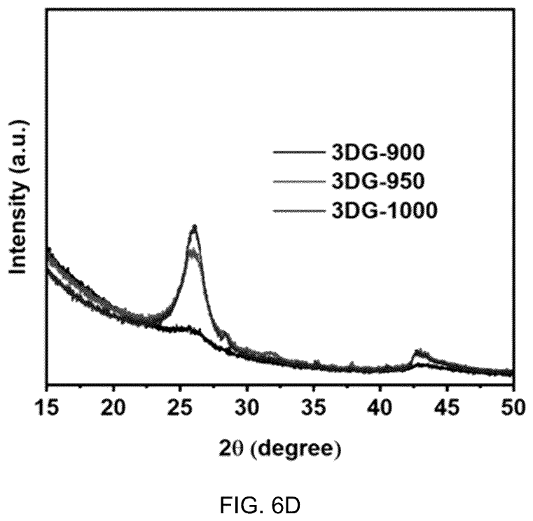

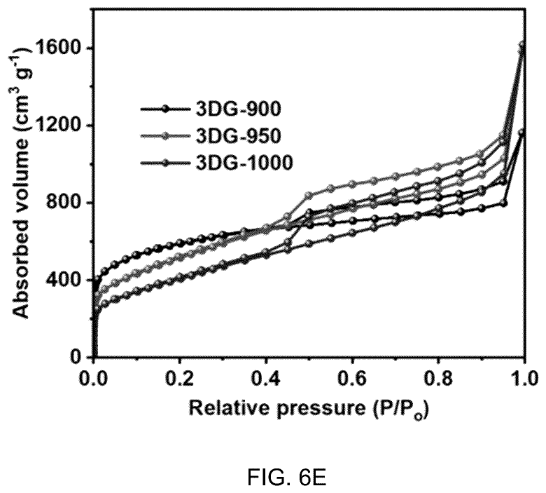

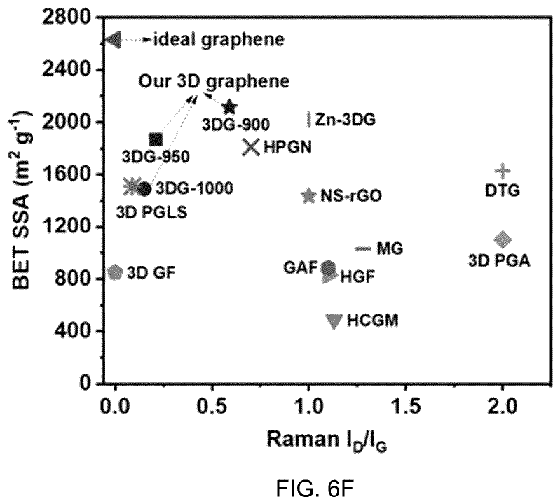

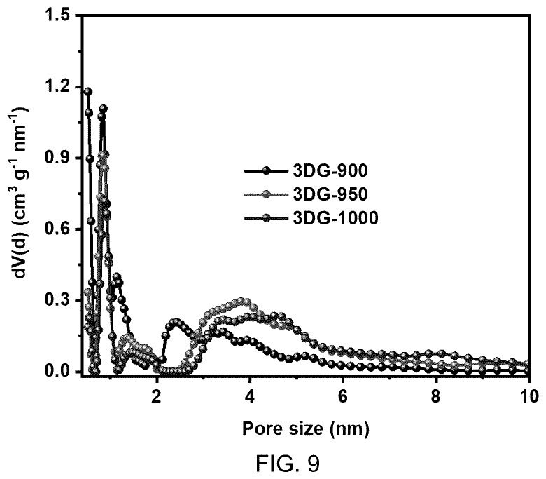

In an embodiment, the invented CEM has hierarchical pore size distribution with micropores (<2.0 nm, usually characterized by N₂ adsorption-desorption isotherm (FIG. 6E and FIG. 9), mesopores (from 2.0 to 50 nm, usually characterized by N₂ adsorption-desorption isotherm (FIG. 6E and FIG. 9), and macropores (>50 nm, for the low-end (50-200 nm), characterized by N₂ adsorption-desorption isotherm and for high end (>200 nm), it could be observed from SEM images (FIG. 4A-FIG. 4C).

Still yet another feature of the invented CEM is its atomic carbon/oxygen ratio. Where state of the art CEM materials comprise a C/O ratio around 16.8, embodiments of the invented CEM comprise a C/O ratio between approximately 20 and approximately 100, preferably between approximately 30 to approximately 70, and typically between approximately 40 and approximately 60.

Surprisingly and unexpectedly, when considering the superior specific surface area of the invented CEM discussed above, the invented CEM comprises an extremely high degree of crystallinity. For example, in an embodiment, the invented CEM comprises a low density of sp³ defects in its graphene carbon lattice such that it has a Raman I_{D}/I_{G} intensity ratio between approximately 0.05 to approximately 1.2 and, in various embodiments, a Raman I_{2D}/I_{G} intensity ratio between approximately 0.2 and approximately 0.8, preferably Raman I_{D}/I_{G} intensity ratio between approximately 0.2 to approximately 0.8 and, in various embodiments, a Raman I_{2D}/I_{G} intensity ratio between approximately 0.4 and approximately 0.8. Both intensity ratios are far superior to prior art CEM having a I_{D}/I_{G} ratio of approximately 1 and a I_{2D}/I_{G} of less than 0.1.

Still yet another salient feature of the invented CEM is the superior conductivity of the material. Where prior art materials have conductivities less than 50 S/m, in various embodiments, the invented CEM comprises conductivities between approximately 500 S/m and approximately 5000 S/m, preferably between approximately 750 S/m and approximately 3000 S/m, and typically between approximately 1000 S/m and approximately 2500 S/m. In some embodiments, the invented CEM comprises a CEM of at least 1000 S/m. Significantly, the invented CEM comprises the above-recited conductivities without the addition of a conductive additive. In various embodiments, the invented CEM is configured to comprise the above-recited conductivities when an electrical current is applied to the CEM.

Significantly, in various embodiments, the invented CEM is configured to comprise any of the above-described features and performance values when an electrical current is applied to the CEM.

### CEM in Supercapacitors

In an embodiment, the invented CEM can be used in one or more of the electrodes of a supercapacitor. Embodiments of capacitors using the invented CEM include supercapacitors of known design wherein the supercapacitor comprises a first electrode, a second electrode, a porous separator positioned between the first and second electrodes, and an electrolyte in electronic and physical contact with the first and second electrodes and the porous separator. In such embodiments, at least one of the first and second electrode comprise the invented CEM. In various embodiments, both electrodes comprise the invented CEM. Supercapacitor embodiments are exemplary and not meant to be limiting. A person having ordinary skill in the art can readily ascertain that the invented CEM is suitable for use in various types of capacitors and other electronic components. The invented CEM is suitable for use in conjunction with conventional supercapacitor components, i.e. electrolytes, separators, etc. For example, in embodiments of supercapacitors using CEM as one or more of the electrodes, the electrolyte comprises KOH, Na₂SO₄, other conventional electrolytes such as H₂SO₄, LiOH, NaOH, K₂SO₄, KCl, NaNO₃, etc., and a combination thereof. A person having ordinary skill in the art will readily understand that the listed electrolytes are exemplary and not meant to be limiting.

As described above, the invented CEM has features and properties that are superior to state of the art CEM. Given these superior features and properties, the invented CEM, when used in one or more electrodes of a capacitor, imbues said capacitor with superior performance over state of the art capacitors. For example, a supercapacitor using the invented CEM as one or both electrodes provides a gravimetric specific capacitance at current density of 1.0 A/g between approximately 50 F/g and approximately 350 F/g, preferably between approximately 100 F/g and approximately 300.0 F/g, and typically between approximately 150 F/g and approximately 250 F/g, an area specific capacitance at current density of 1.0 A/g between approximately 0.1 F/cm² and approximately 15.0 F/cm², preferably between approximately 0.5 F/cm² and approximately 10.0 F/cm², and typically between approximately 1.0 F/cm² and approximately 6.0 F/cm², and a maximum gravimetric energy density at current density of 1.0 A/g between approximately 3.0 Wh/kg and approximately 30.0 Wh/kg, preferably between approximately 5.0 Wh/kg and approximately 25.0 Wh/kg, and typically between approximately 8.0 Wh/kg and approximately 20.0 Wh/kg. Each of these values is superior to the capabilities of supercapacitors using state of the art CEM, as shown in TABLE 2.

TABLE 2
Supercapacitor Performance

| | | | | Maximum |
|---|---|---|---|---|
| | | Gravimetric | | gravimetric |
| | | specific | Areal specific | energy |
| Electrode | | capacitance | capacitance | density |
| Material | Electrolyte | (F/g) | (F/cm²) | (Wh kg⁻¹) |
| Invented | 6M KOH | 182 | 5.48 | 10.1 |
| CEM | 1M Na₂SO₄ | 156 | 2.34 | 19.2 |
| Commercial | 6M KOH | 124 | 3.58 | 6.9 |
| SOTA | 1M Na₂SO₄ | 102 | 1.53 | 12.8 |
| (Activated | | | | |
| Carbon: | | | | |
| Kuraray | | | | |
| YP 50F) | | | | |

Significantly, in various embodiments, a supercapacitor using the invented CEM in one or more of its electrodes is configured to comprise any of the above-described features and performance values when a voltage is applied across said supercapacitor.

### Method of Making CEM

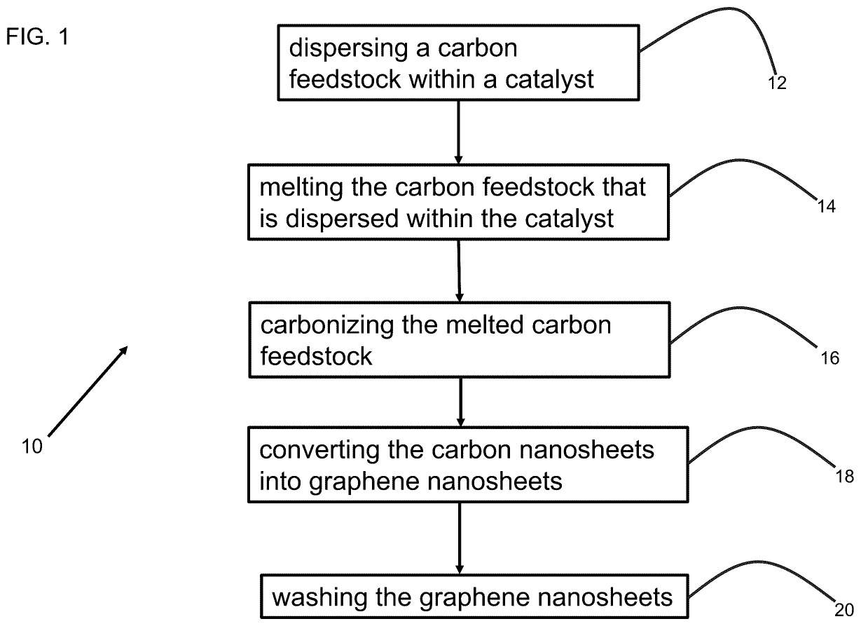

The invention also provides a method for generating CEM that overcomes disadvantages over the prior art, a schematic for that method 10 shown in FIG. 1. The method 10 begins with dispersing a carbon feedstock within a catalyst 12, thereby forming a mixture, wherein the catalyst comprises particles. Subsequently, the method 10 continues with melting the carbon feedstock that is dispersed within the catalyst 14, thereby liquifying the carbon feedstock that then coats catalyst particles and infiltrates spaces between said catalyst particles. After the carbon feedstock is melted, the method 10 continues by carbonizing the melted carbon feedstock 16, thereby forming an interconnected 3D network of carbon nanosheets. The method continues by converting the carbon nanosheets into graphene nanosheets 18. Subsequently, the method continues by washing the graphene nanosheets 20, thereby forming CEM. In an embodiment, the method continues with recovering and regenerating the catalyst from wash eluent, and, optionally, repeating the method using recovered catalyst.

An important feature of the method is the carbon feedstock used. Prior art methods use solid carbons that do not mix well with catalysts and produce poor electrode materials. The instant invention, conversely, utilizes liquid or semi-liquid carbon feedstocks that mix well with catalyst particles and produce superior electrode materials from the prior art. In an embodiment, any liquid or semi-liquid carbon feedstock is suitable for use in the instant method. Exemplary and suitable carbon feedstocks comprise petroleum pitch, coal tar pitch, other liquid carbonaceous materials, pitch-based carbon-containing materials, heavy oil, bio-oil, bio-tar, meltable biomasses (such as sugar, lignin etc.), meltable and carbonizable plastics (such as polyethylene terephthalate (PET), polyvinyl alcohol (PVA), polylactic acid (PLA), etc.), and combinations thereof. A person of ordinary skill in the art will readily understand that these materials are exemplary and not meant to be limiting. The invented method is suitable for use with any liquid or semi-liquid carbonaceous material suitable for generating graphene using the instant method.

As described above, the invented method 10 begins with dispersing a carbon feedstock within a catalyst 12. Any catalyst suitable for catalytic graphenization processes may be used to accomplish the instant method. Exemplary and suitable catalysts comprise K₂CO₃, Na₂CO₃, Li₂CO₃ and combinations thereof. This list of catalysts is exemplary and not meant to be limiting. Additional and suitable catalyst include precursor compounds that thermally decompose into active catalyst at temperatures between approximately 150° C. to approximately 300° C., said catalyst precursor compounds comprising KHCO₃, NaHCO₃, LiHCO₃, and combinations thereof, wherein these catalyst precursor compounds would thermally decompose into the active catalyst K₂CO₃, Na₂CO₃, and Li₂CO₃ respectively during the instant method. A person having ordinary skill in the art will readily recognize that the instant method is suitable for use with myriad other catalysts.

The dispersing step comprises any suitable method for homogenously or approximately homogenously mixing the carbon feedstock with the catalyst. Exemplary and suitable methods for homogenously mixing include grinding, ball milling, solution mixing, and combinations thereof. This list of mixing methods is exemplary and not meant to be limiting. A person having ordinary skill in the art will readily recognize that the invented method may use any suitable method for homogenous mixing.

A salient feature of the invention is the wt:wt ratio of carbon feedstock to catalyst comprising the mixture of dispersing step 12. In an embodiment, the dispersing step generates a mixture having any wt:wt ratio of carbon feedstock to catalyst that is suitable for use of the instant method to generate CEM materials. In an exemplary embodiment, the wt:wt ratio of carbon feedstock to catalyst in the mixture is between approximately 1:1 and approximately 1:100, preferably between approximately 1:3 and approximately 1:50, and typically between approximately 1:5 and approximately 1:15. Surprising an unexpectedly, the high wt:wt ratio of carbon feedstock to catalyst used in the instant method provides CEM materials with superior qualities and performance to prior art CEM materials made using methods typically using carbon feedstock to catalyst ratios between 1:1 to 1:5.

As shown and described above, after the dispersing step 12, the method continues with the melting step 14. Generally, the melting step comprises heating the mixture (carbon feedstock dispersed in catalyst) until the carbon feedstock melts. The melting step 14 occurs at temperatures between approximately 30° C. and approximately 300° C., and typically above approximately 110° C. A person having ordinary skill in the art will readily understand that this range of temperatures for the melting step 14 are exemplary, where the temperature during the melting step 14 can be adjusted according to materials used in various embodiments of the invented method.

As shown and described above, after the melting step 14, the method continues with carbonizing the melted carbon feedstock 16, thereby forming an interconnected 3D network of carbon nanosheets. The carbonizing step 16 comprises heating the melted carbon feedstock to any temperature suitable to solidify the melted carbon feedstock and form said interconnected 3D network of carbon nanosheets, wherein the carbonizing step further comprises heating the melted carbon feedstock to temperatures between approximately 300° C. and approximately 900° C., typically between approximately 500° C. and approximately 700° C. A person having ordinary skill in the art will readily understand that this range of temperatures for the carbonizing step 16 are exemplary, where the temperature during the carbonizing step 16 can be adjusted according to materials used in various embodiments of the invented method.

Returning to FIG. 1, after the carbonizing step 16, the method continues with converting the carbon nanosheets into graphene nanosheets 18. Generally, the converting the carbon nanosheets step 18 comprises heating said carbon nanosheets to any temperature suitable to convert said carbon nanosheets to graphene nanosheets in the presence of catalyst. In an embodiment, the converting step 18 comprises heating the carbon nanosheets to a temperature above the melting point of the catalyst, that temperature between approximately 850° C. and approximately 1100° C., typically between approximately 900° C. and approximately 1000° C. A person having ordinary skill in the art will readily understand that this range of temperatures for the converting step 18 are exemplary, where the temperature during the converting step 18 can be adjusted according to materials used in various embodiments of the invented method.

After the converting step 18 the method continues with washing the graphene nanosheets 20, thereby forming CEM. The washing step 20 generally comprises rinsing said graphene nanosheets with water and or other suitable solvents to dissolve any leftover catalyst and or partially reacted catalyst into wash eluent, giving the finalized CEM product.

A salient feature of the invention is that the catalyst can be recovered and regenerated and reused in subsequent repetitions of the invented method. In an embodiment, recovering and regenerating the catalyst comprises adding a bicarbonate to the wash eluent to form a recovery solution, followed by drying said recovery solution, wherein drying said recovery solution produces recovered and regenerated catalyst that can be used to repeat the invented method 10. In an embodiment, the bicarbonate comprises a bicarbonate suitable for neutralizing partially reacted catalyst in the wash eluent and regenerating the catalyst. Specifically, in embodiments of the method 10 using K₂CO₃ as the catalyst, the bicarbonate comprises potassium bicarbonate (KHCO₃). As discussed below in the example section, in embodiments using K₂CO₃ catalyst, the potassium bicarbonate, when added to the wash eluent containing dissolved K₂CO₃ along with KOH (partially reacted K₂CO₃ catalyst), the reaction of EQUATION 5 below occurs to produce K₂CO₃.

The ability to recover and reuse the catalyst used in the instant method is a significant feature of the invention. Costs associated with purchasing, processing, and disposing of catalyst are significant. These costs are avoided in the instant invention as the catalyst can be recovered and reused repeatedly. Empirical data provides that recovered and regenerated catalyst, when used in the instant method, produces the invented CEM as desired. In an embodiment, CEM produced using recovered and regenerated catalyst is identical to CEM made using fresh catalyst.

### Examples

In an embodiment, the invention provides a method that uses an inexpensive and abundant carbon feedstock, coal tar pitch (CTP), along with a potassium carbonate (K₂CO₃) catalyst in a simple, tube-furnace based, process to make microscopic 3D graphenes with carbon mass yields as high as ˜37%. The quality of these 3D graphenes is indicated by Raman I_{D}/I_{G} ratios as low as 0.15 and the highest specific surface area reported for this material, yet, at 2113 m² g⁻¹. The K₂CO₃ catalyst was recycled at a mass recovery rate of 95% which was demonstrated for 10 full cycles with the quality of 3D graphene retained after each cycle. This material has outstanding electrochemical capacitive properties with a gravimetric specific capacitance of 182.6 F g⁻¹ at a current density of 1.0 A g⁻¹. This is unique because it is achieved at a mass loading of 30 mg cm 2, which is 3 times higher than current commercial requirements for practical supercapacitor devices, resulting in ultra-high areal capacitance of 5.48 F cm⁻². These capacitive properties are among the highest, if not the highest, ever reported for graphene-based supercapacitor devices.

Exemplary embodiments overcome a long-standing challenge for fabricating practical supercapacitor electrodes which involves balancing two conflicting characteristics: high porosity and high material density. The invention addresses this challenge by producing an electrically conductive 3D graphene possessing a pore structure that does not collapse under harsh compression giving it both high porosity and reasonable packing density. This allows for the high electron and ion transport rates needed to achieve outstanding electrocapacitive properties at ultrahigh mass loadings. Achieving these properties at ultrahigh mass loading overcomes the dilution of gravimetric energy and power densities that occurs in practical supercapacitor devices from the additional weight of current collectors, separators, electrolyte, binder, connectors, and packaging. As such, the simple synthesis method (10 in FIG. 1) shown and discussed above allows for the inexpensive production of electrodes and opens new opportunities for using graphene-based materials more broadly in practical supercapacitor devices.

### Synthesis and Characterization of 3D Graphene

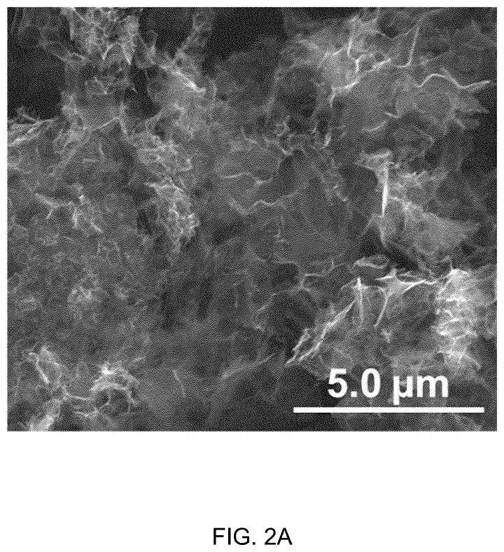

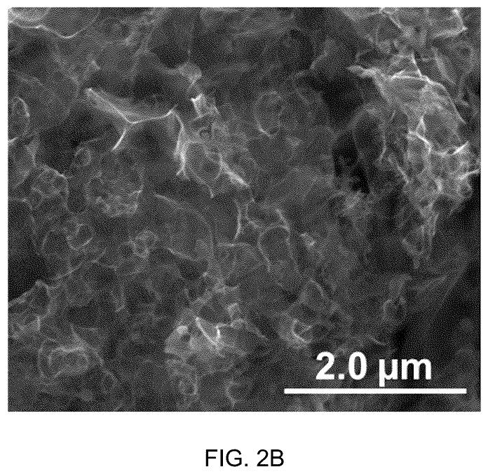

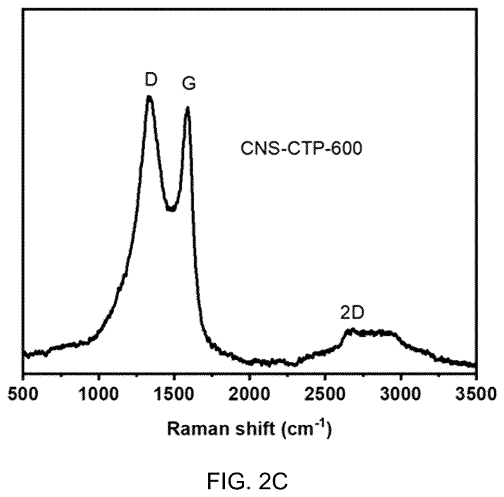

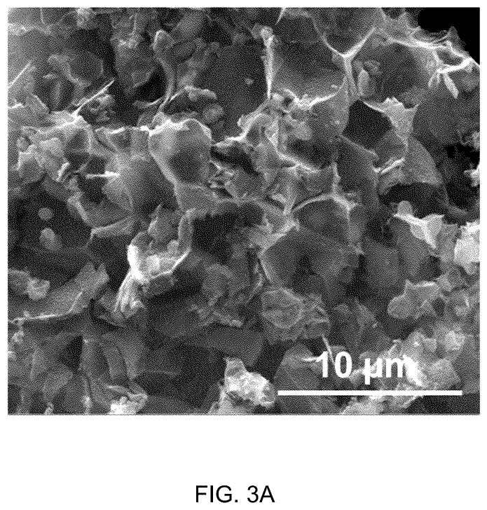

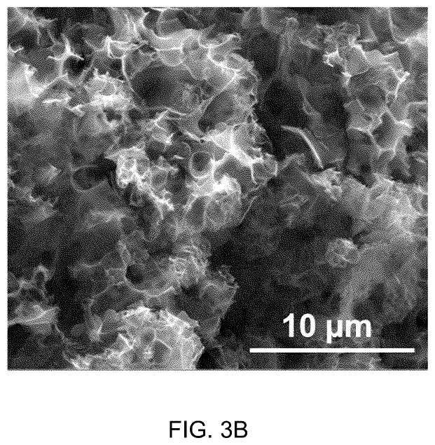

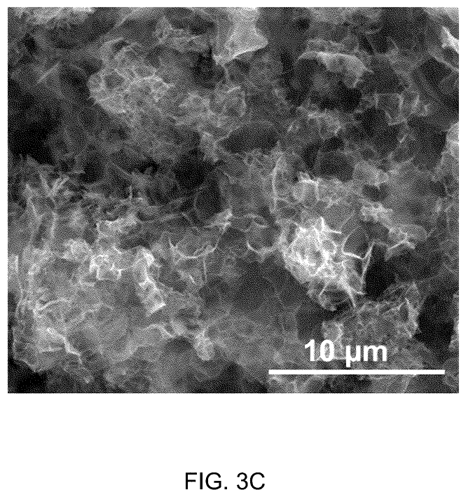

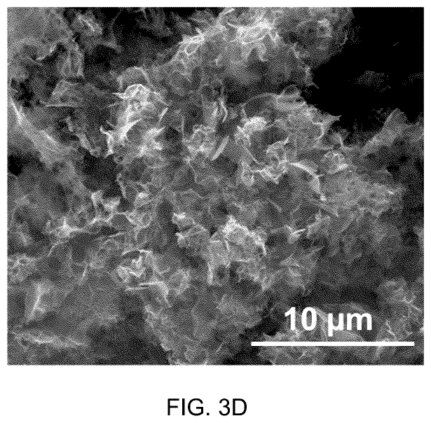

As discussed above, the invented synthesis process of microscopic 3D graphene CEM by catalytic graphenization is schematically illustrated in FIG. 1. In an exemplary embodiment, CTP is first homogeneously dispersed in K₂CO₃ by ball milling for 15 minutes with a mass ratio of CTP:K₂CO₃ at 1:10. This solid mixture is then heated beyond the melting point of CTP (˜110° C.) which converts the CTP into a liquid that coats K₂CO₃ particles and infiltrates the spaces between them. The mixture is then heated to 600° C. under nitrogen atmosphere, which carbonizes the melted CTP and causes formation of an interconnected 3D network of carbon nanosheets as evidenced by SEM and Raman characterization (FIGS. 2A-2C). The sample is then heated to 900-1000° C., which leads to the catalytic conversion of carbon nanosheets into graphene nanosheets. Afterwards, the K₂CO₃ is rinsed away with water and recovered for recycling and reuse (details below) and the product dried, which leaves behind fluffy carbon powders with tap densities as low as 0.035 g cm 3, indicating a highly porous structure. The synthesis yield, on a carbon basis, at 900, 950 and 1000° C. (denoted as 3DG-900, 3DG-950 and 3DG-1000) were 36.8, 33.2 and 32.7 wt. %, respectively. Using longer graphenization times causes a dramatic reduction in the carbon yield and surface area of the sample. Additionally, using CTP:K₂CO₃ mass ratios that are below 1:10 still results in a microscopic 3D graphitic porous carbons whereas using higher mass ratio leads to lower production yield (FIGS. 3A-3D).

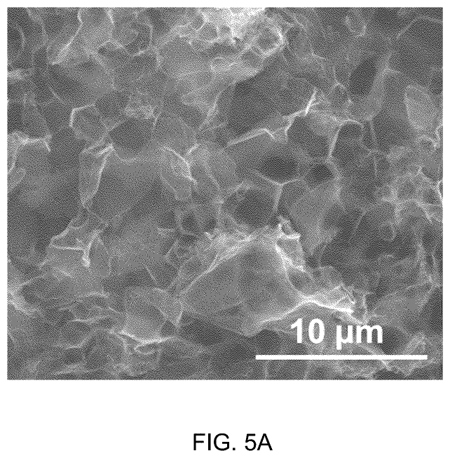

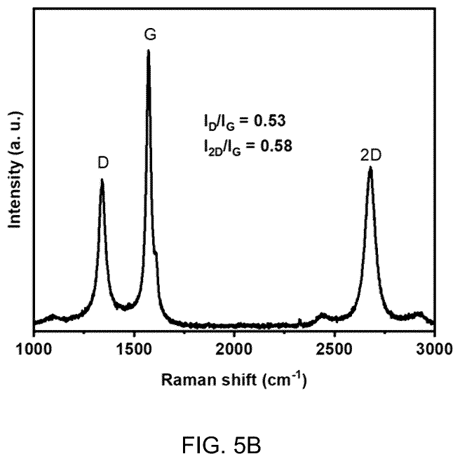

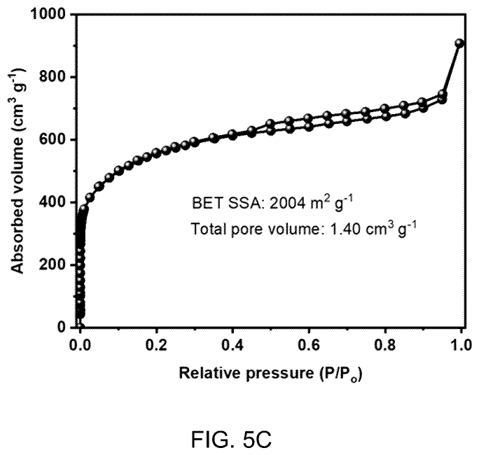

Scanning electron microscopy (SEM) images of the 3DG samples (FIGS. 4A-4C) show a hierarchical, interconnected, 3D networks of thin, crumpled, graphene sheets. This network possesses irregularly shaped, macro- and meso-scale pore structures with sizes ranging from a few microns down to tens of nanometers. The shape and size of these macro- and meso-scale structures result, in part, from the shape of K₂CO₃ particles and their templating role during the carbonization step which is confirmed by experiments with varying particle sizes (FIGS. 5A-5C) to create larger macro- and meso-scale structures in the final carbon product. The transmission electron microscopy (TEM) images in FIGS. 4D-4F illustrate the microstructure is composed of stacks of graphene sheets with fewer layers at lower synthesis temperatures and more layers at higher synthesis temperatures. The number of graphene layers is estimated from high resolution TEM (HR-TEM) lattice fringes in FIGS. 4G-4I 3-8 layers for 3GD-900, 2) 5-15 layers for 3GD-950, and 3) 5-20 layers for 3DG-1000. The variation of graphene layers with synthesis temperature can be explained by the molten K₂CO₃ viscosity. At 900° C., which is slightly above the K₂CO₃ melting point (891° C.), the molten salt has a higher viscosity, limiting the movement of graphene sheets that are formed, as well as their restacking to generate thicker microstructures. However, at higher temperature, the lower viscosity of the molten salt allows graphene sheets that are formed to move more freely, leading to additional restacking which increases the number of graphene sheets observed in the microstructure of these 3DGs.

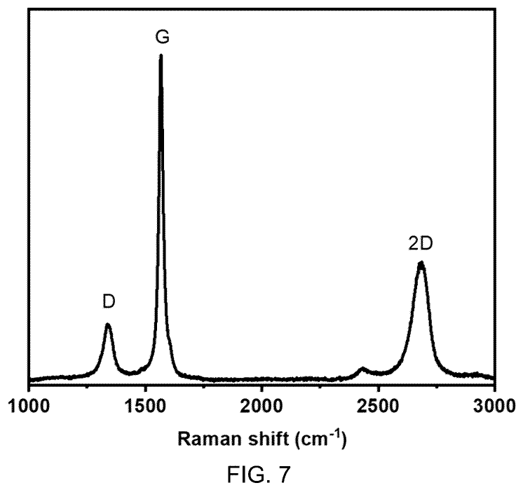

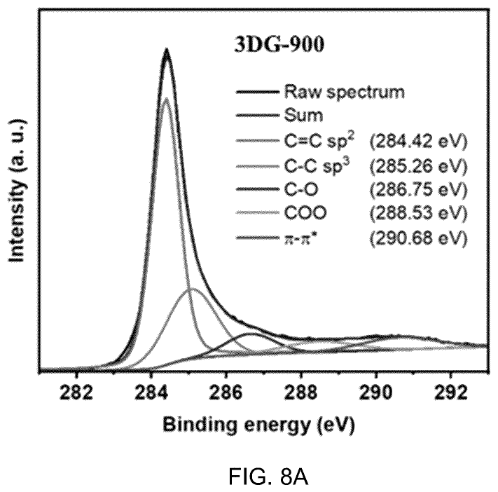

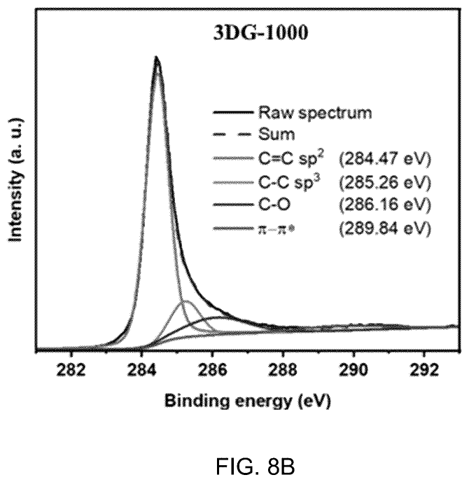

The datasets shown in FIGS. 6A-6F illustrate that the 3DG samples are exceptionally high quality. The Raman spectra (FIG. 6A) show that the I_{D}/I_{G} ratio (TABLE 3) varies from 0.59 for 3DG-900 to only 0.15 for 3DG-1000, which is significantly lower than comparable graphene materials and approaches that of a commercially available graphite sample with an I_{D}/I_{G} of 0.17 (FIG. 7). The XPS survey spectra (FIG. 6B) show the prominent C1s peaks and minor O1s peaks, yielding an oxygen atomic percentage of only 1.6-2.1%. This produces a C/O ratio that varies from 44.6 to 61.5 for these samples and is far higher than comparable graphene materials. The deconvoluted C1s spectra (FIG. 4C and FIG. 8) demonstrate that the Cₛₚ₂ contribution to the total C1s lineshape is: 1) 57.2% for 3DG-900, 2) 70.3% for 3DG-950 and 3) 73.1% for 3DG-1000. XRD patterns exhibit broad (002) peaks at ˜26°, which result from the thin crystalline graphene sheets in the sample. The intensity of the (002) peak increases with the graphenization temperature, due to the thickness of the graphene sheet structures, which is also consistent with the micrographs shown in FIGS. 4G-4I.

TABLE 3
Production yield and properties of CEM

| | | QSDFT | QSDFT | BJH | Total | | XPS | |
|---|---|---|---|---|---|---|---|---|
| | | micropore | mesopore | macropore | pore | Average | atomic | Production |
| | | volume | volume | volume | volume | Raman | C/O | yield |
| | | (cm³ g⁻¹) | (cm³ g⁻¹) | (cm³ g⁻¹)^{a)} | (cm³ g⁻¹)^{b)} | I_{D}/I_{G}^{c)} | ratio | (wt. %) |
| 3DG-900 | 2113 | 0.59 | 0.78 | 0.39 | 1.80 | 0.59 | 46.6 | 36.8 |
| 3DG-950 | 1866 | 0.35 | 1.47 | 0.65 | 2.45 | 0.21 | 51.6 | 33.2 |
| 3DG-1000 | 1490 | 0.23 | 1.54 | 0.82 | 2.50 | 0.15 | 61.5 | 32.7 |

^{a)}Volume of macropore with size of 50-200 nm was calculated from the adsorption data by BJH method;
^{b)}Total pore volume at P/Po = 0.995;
^{c)}Average Raman I_{D}/I_{G} were calculated from spectra measured at 5 different positions.

N₂ isotherms (FIG. 6E) display combined type I (b) and type IV (a) characteristics, indicating a hierarchical pore structure consisting of macro-, meso-, and micro-pores. The total pore volumes estimated at a relative pressure of 0.995 were 1.80, 2.45, and 2.50 cm³ g⁻¹ for 3DG-900, 3DG-950, and 3DG-1000, respectively. Specific surface areas (SSA) calculated by the Brunauer-Emmett-Teller (BET) method were 2,113, 1,866, and 1,490 m² g⁻¹ for 3DG-900, 3DG-950, and 3DG-1000, respectively, and are higher than previous literature reports for comparable materials (FIG. 6F, TABLE 3). Notably, 3DG-900 has the highest BET SSA reported for 3D graphene materials. The outstanding specific surface area of 3DG-900 is mainly caused by a high fraction of micropores in the pore structure (FIG. 9). At higher graphenization temperatures, the reconstruction of microstructure of graphene sheets due to lower viscosity of molten salt resulted in a lower micropore volume with significant increase of mesopore and macropore volumes, leading to a decrease of BET SSA.

FIG. 6F directly compares the BET SSA and Raman I_{D}/I_{G} of the 3DG sample from this invention to existing literature and illustrates the properties of the 3DG exceed previous reports and start to approach those of ideal graphene. As expected for a highly carbon, the electrical conductivity of the samples with 5 wt. % polytetrafluoroethylene (PTFE) binder compressed at 4.0 ton cm⁻² was 1,295, 1,933 and 2,370 Sm⁻¹ for 3DG-900, 3DG-950, and 3DG-1000, respectively.

### Electrochemical Capacitive Performance of CEM Supercapacitors

The microstructure, crystallinity, porosity, and electrical conductivity of the 3DGs make them exceptional candidates for supercapacitor applications. 3DG-900 electrodes were fabricated using 95 wt % of 3DG-900 as active electrode material and 5.0 wt % PTFE as binder without using any conductive additive. 3DG-900 and PTFE were compressed at 4.0 ton cm⁻² into compact pellet electrodes with mass loading of 5.0, 10, 20 and 30 mg cm⁻². Most literature reports use mass loadings of 1.0-5.0 mg cm⁻², whereas the current requirement for fabricating commercial devices is ≥10.0 mg cm⁻². As such, the results using the presently invented CEM at mass loadings of 10-30 mg cm⁻² are directly relevant to fabricating and engineering practical supercapacitor devices.

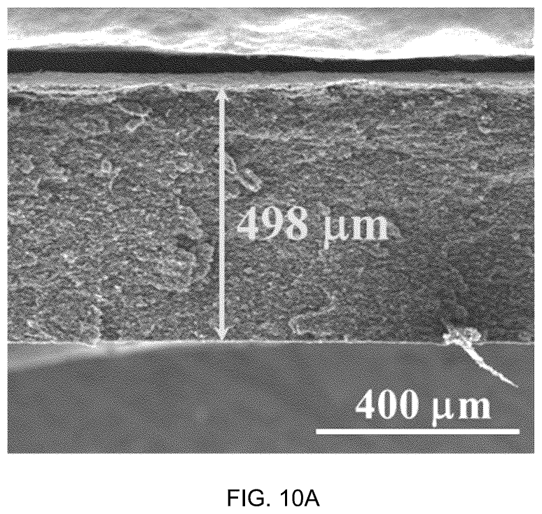

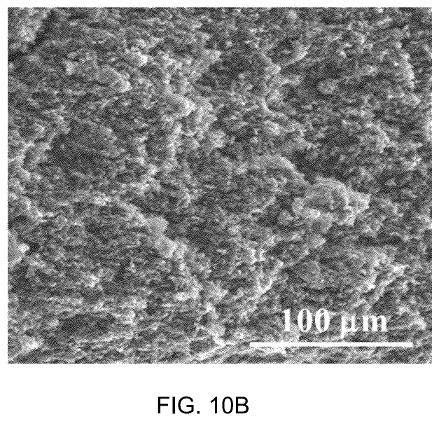

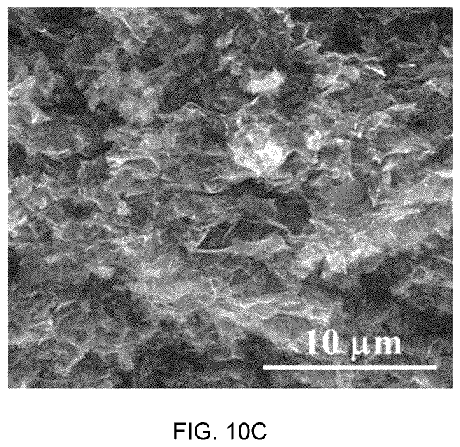

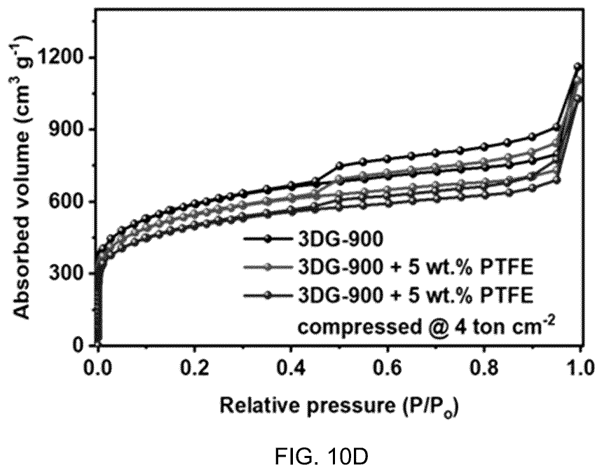

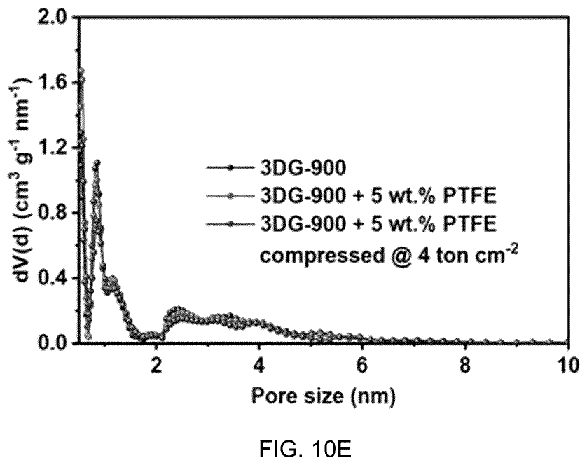

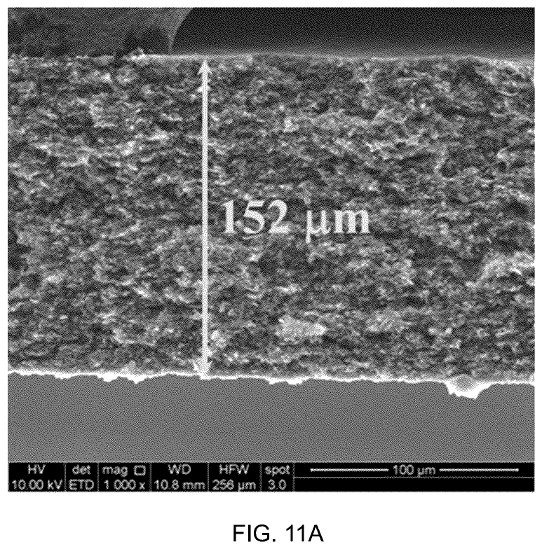

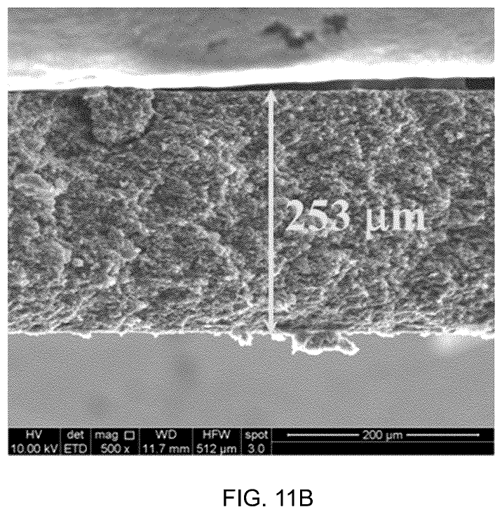

Compression of the 3DG-900 at 4 tons cm⁻² with PTFE binder did not adversely affect the structure or porosity of the active electrode material. SEM images (FIGS. 10A-10C and FIGS. 11A-11C) show that 150-770 micron-thick electrodes retain the hierarchical, interconnected, network of graphene sheets, as well as the macro- and meso-porosity noted in FIG. 6A for the as-synthesized material. The N₂ isotherms and pore size distributions (FIGS. 10D-10E) were essentially unchanged as evidenced by total pore volumes and BET SSA which only decreased by ˜9 and ˜15%, respectively (TABLE 4). The minor decrease in SSA, total pore volume as well as pore size distribution despite harsh electrode fabrication process indicates the micro-structure of 3DG-900 is largely preserved. The existence of a highly hierarchical micro-, meso-, and macro-porous structure is highly desired, especially for a thick electrode, since it facilitates electrolyte ion diffusion throughout the electrode, which enhances electrochemical performance.

TABLE 4
Textural Properties of CEM Electrode

| | | QSDTF | QSDTF | BJH | Total |
|---|---|---|---|---|---|
| | BET | micropore | mesopore | macropore | pore |
| | SSA | volume | volume | volume | volume |
| | (m² g⁻¹) | (cm³ g⁻¹) | (cm³ g⁻¹) | (cm³ g⁻¹)^{a)} | (cm³ g⁻¹)^{b)} |
| 3DG-900 | 2113 | 0.59 | 0.78 | 0.39 | 1.80 |
| 3DG-900 + | 1958 | 0.53 | 0.76 | 0.35 | 1.71 |
| 5.0 wt. % | | | | | |
| PTFE | | | | | |
| 3DG-900 + | 1789 | 0.48 | 0.72 | 0.28 | 1.64 |
| 5.0 wt. % | | | | | |
| PTFE | | | | | |
| compressed | | | | | |
| @ 4.0 | | | | | |
| ton cm⁻² | | | | | |

^{a)}Volume of macropore with size of 50-200 nm was calculated from the adsorption data by BJH method;
^{b)}Total pore volume at P/Po = 0.995;

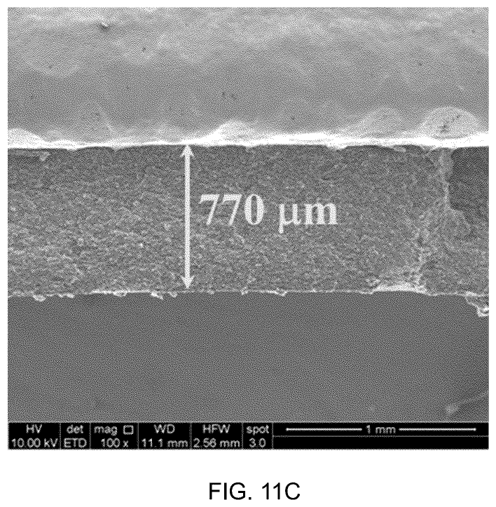

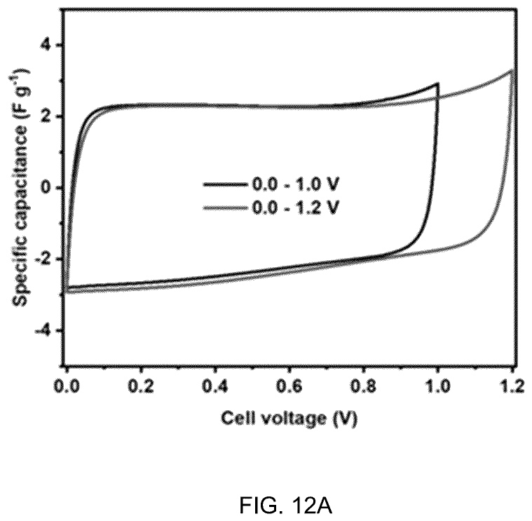

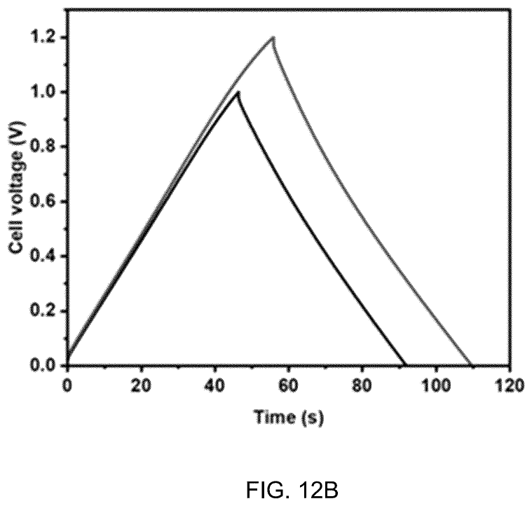

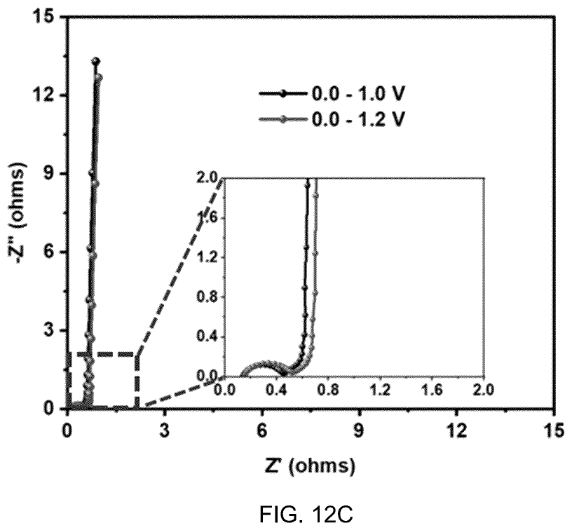

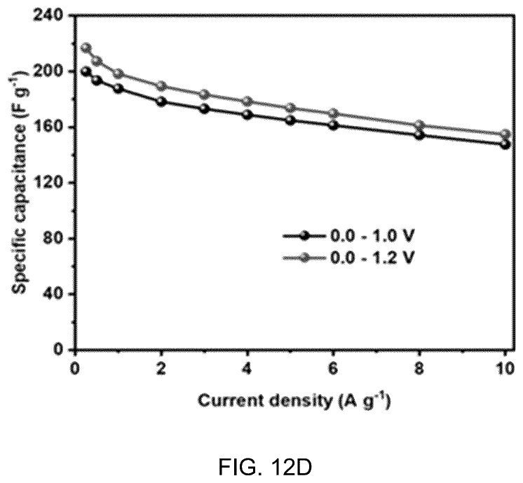

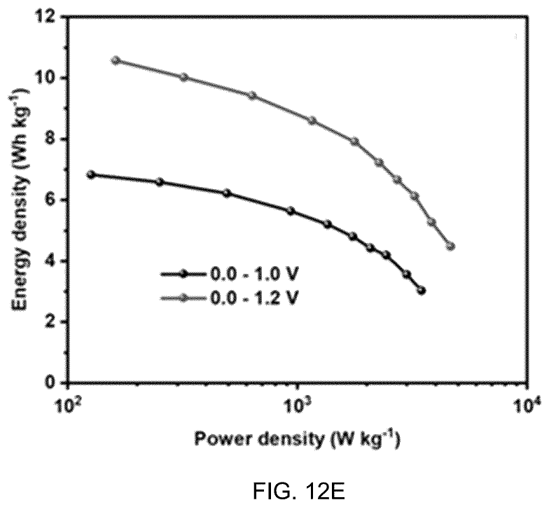

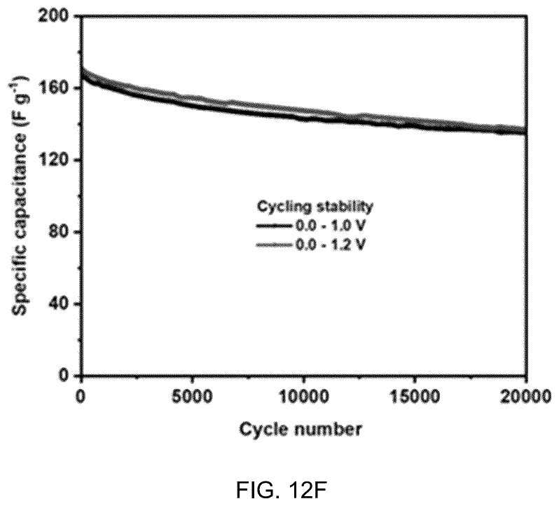

The performance of the 3DG-900 as a supercapacitor electrode was evaluated in two-electrode symmetric cells using 6M KOH aqueous electrolyte. Taking advantage of chemically inert surface of 3DG-900 with very low oxygen content, 3DG-900 supercapacitors were tested at extended working voltage of 0-1.2 V (instead of 0-1.0 V) which could increase the energy density by up to 44%. For comparison, tests were also conducted that restricted the working voltage of 0-1.0 V which yielded nearly identical electrochemical performance except with a lower energy density (FIGS. 12A-12E).

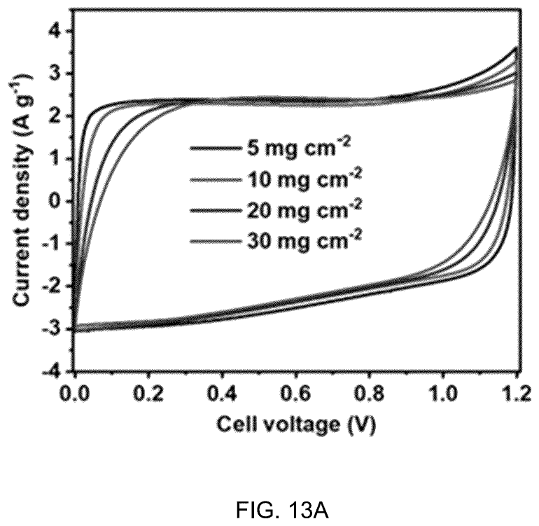

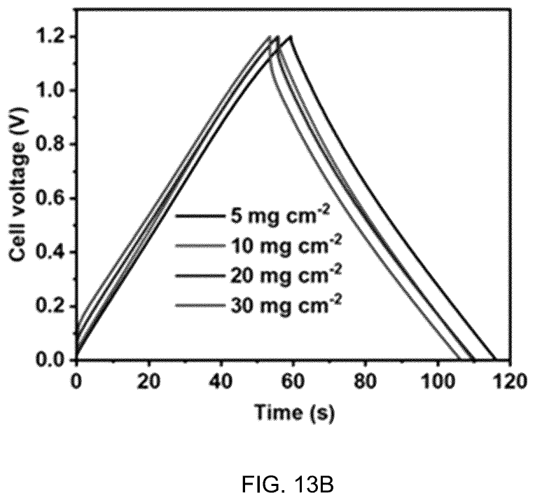

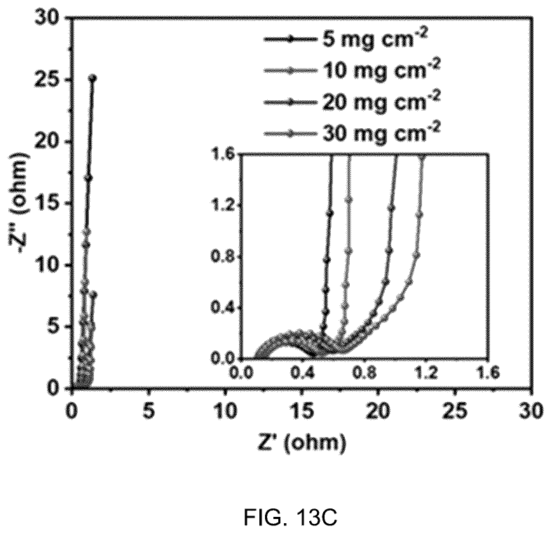

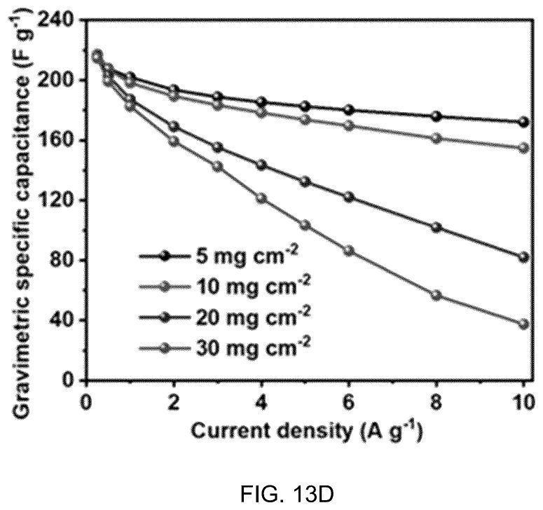

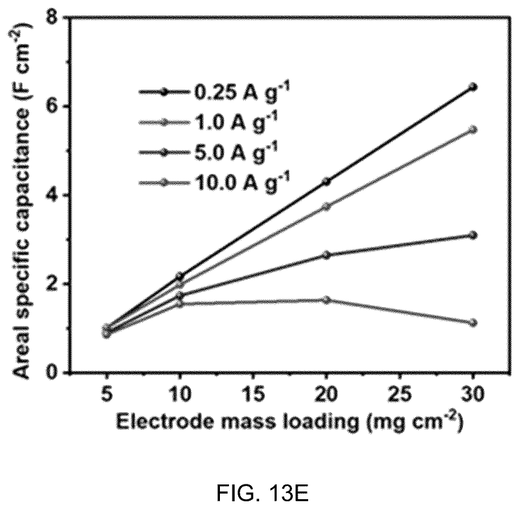

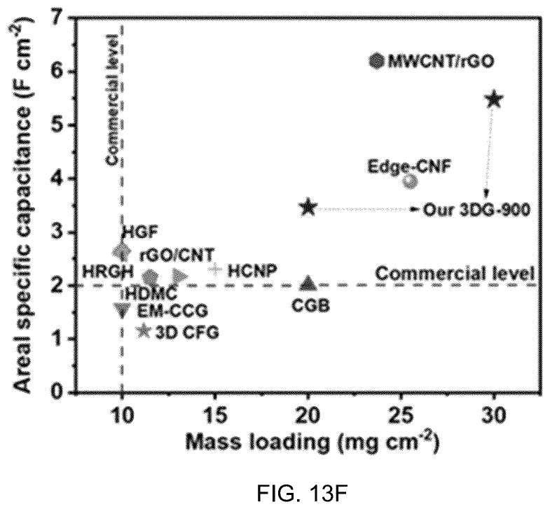

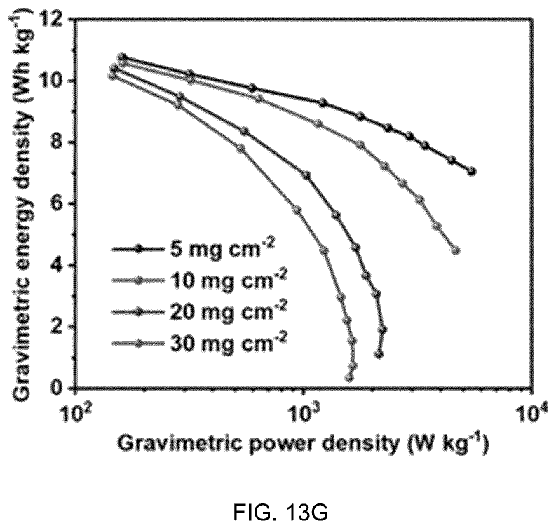

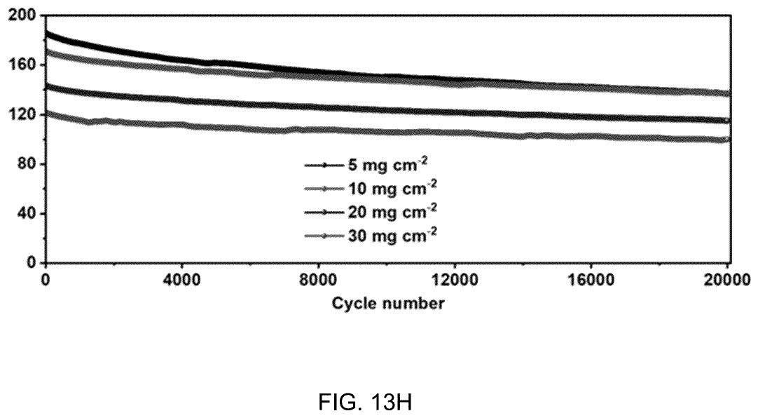

Cyclic voltammetry (CV) curves (FIG. 13A) at 5 and 10 mg cm⁻² exhibit a rectangular shape, indicating nearly ideal electrical-double-layer capacitive behavior. At 20 and 30 mg cm⁻², the CV curves slightly distort to a quasi-rectangular shape due to longer electrolyte ion diffusion through the electrode. The minor distortion of CV curve shapes at high mass loadings indicates the hierarchical pore structure is retained which still allows effective ion transport to occur in the thicker electrodes used in the invention described herein.

Galvanostatic charge-discharge (GCD) curves at the current density of 1.0 A g⁻¹ (FIG. 13B) were symmetric and triangular, which further confirms the nearly ideal electrical-double-layer capacitive behavior of 3DG-900 electrodes. In addition, a very small voltage drop (IR drop) is observed at the beginning of the discharge curve that increased from 0.008 V to 0.021, 0.049 and 0.082 V at electrode areal mass loading of 5.0 to 10.0, 20.0 and 30.0 mg cm⁻², respectively, indicating an increase in internal electrode resistance. The equivalent series resistances (ESR) calculated from the IR drops were also very small at 0.60, 0.79, 0.92 and 1.03 ohms, respectively.

Nyquist plots (FIG. 13C) show the typical semicircle in the high-frequency region and a nearly vertical line in the low-frequency region, indicating nearly ideal capacitive behavior. The middle-to-high frequency region (FIG. 13C inset) shows 45° lines in the Warburg region which is associated with the resistance from ion diffusion in the electrode. The Warburg region gradually increases at higher mass loadings due to a longer ion diffusion distance in these thicker electrodes which suggests that ion diffusion plays a dominant role in controlling the rate capability. The ESR was determined by extrapolating the vertical portion of the plot to the real axis and was 0.53, 0.68, 0.91 and 1.14 ohms for areal mass loadings of 5.0, 10.0, 20.0, and 30.0 mg cm⁻², respectively, which is consistent with the ESR obtained above from IR drops. The small ESR values observed result from the high electrical conductivity and well-preserved hierarchical micro-, meso-, and macro-porous structure of 3DG-900, providing efficient ion transport channels and small ionic resistance.

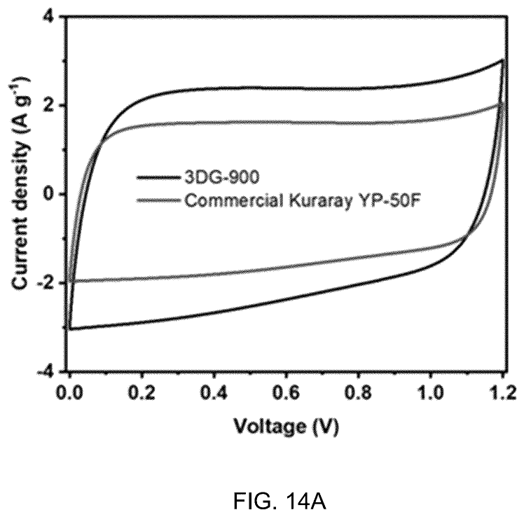

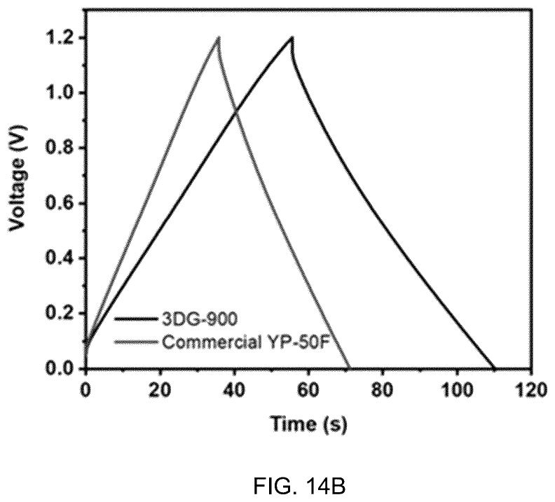

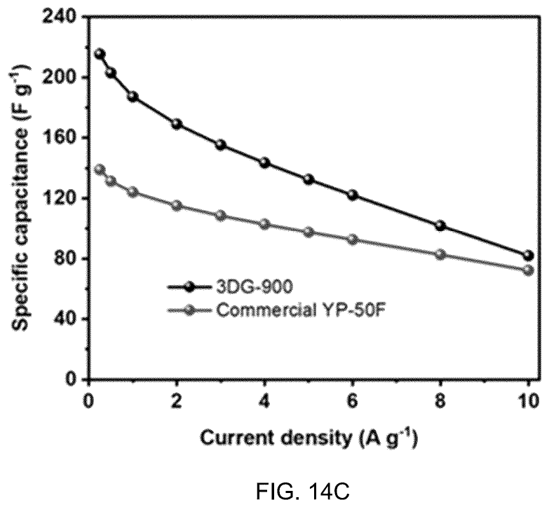

The gravimetric specific capacitances (C_{g}) of 3GD-900 calculated from the slope of the discharge curves at various current densities are shown in FIG. 13D. At a low current density of 0.25 A g⁻¹, C_{g} was ˜215 F g⁻¹ regardless of the areal mass loading. At a medium current density of 1.0 A g⁻¹, C_{g} decreased slightly from 202, 198, 187, and 182 F g⁻¹ at mass loadings of 5, 10, 20 and 30 mg cm⁻², respectively. These C_{g} values are ˜50% higher than what is observed when we evaluate commercial YP-50F activated carbon as a benchmark material under identical testing conditions (FIG. 14C). These C_{g} values are also comparable to the best values reported for graphene materials in previous literature for high mass loading supercapacitors. The achievement of high specific capacitance at ultrahigh mass loading resulted in ultrahigh areal capacitance of 3DG-900. FIG. 13E displays the linearly increase of areal capacitance with increase of mass loading, up to 6.44 F cm⁻² at current density of 0.25 A g⁻¹, which is more than 3 times higher than current commercial requirement. Even at medium current density of 1.0 A g 1, areal capacitance of 3DG-900 was still as high as 5.48 F cm⁻², which is the second-best value reported for carbonaceous materials at high mass loadings (FIG. 13F).

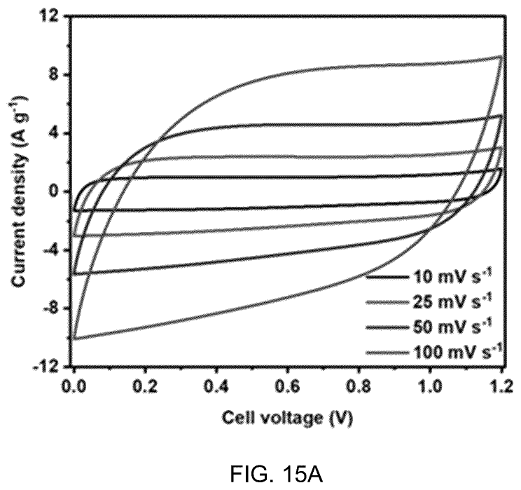

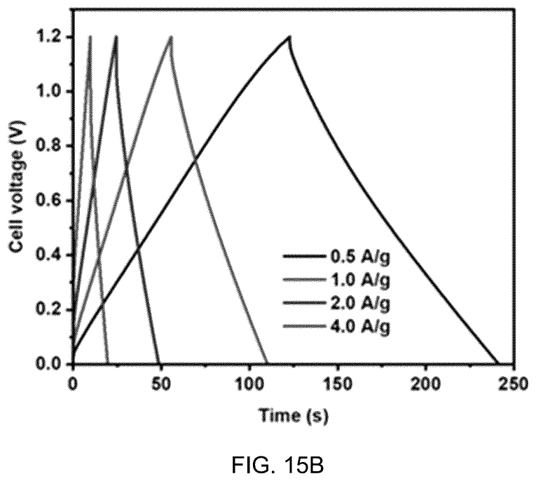

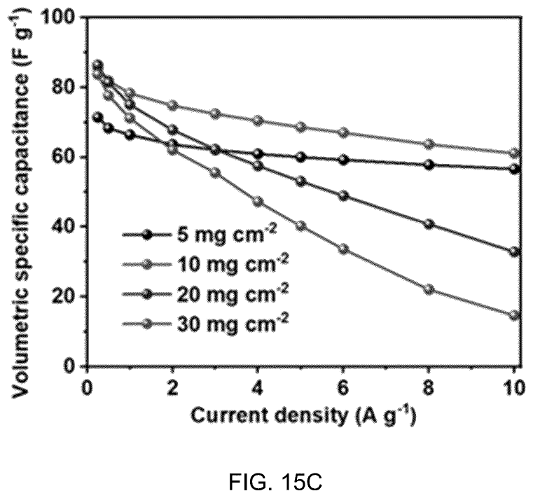

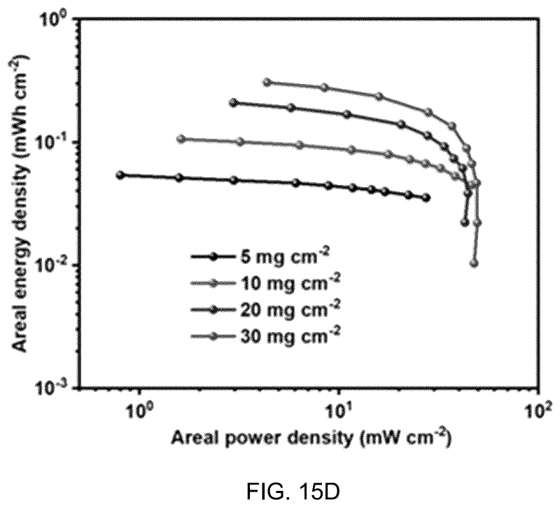

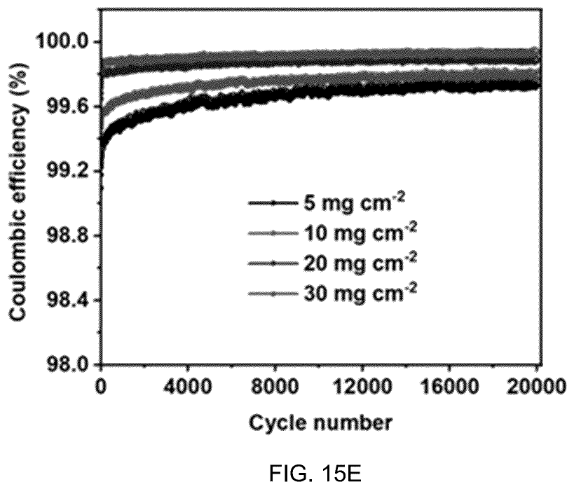

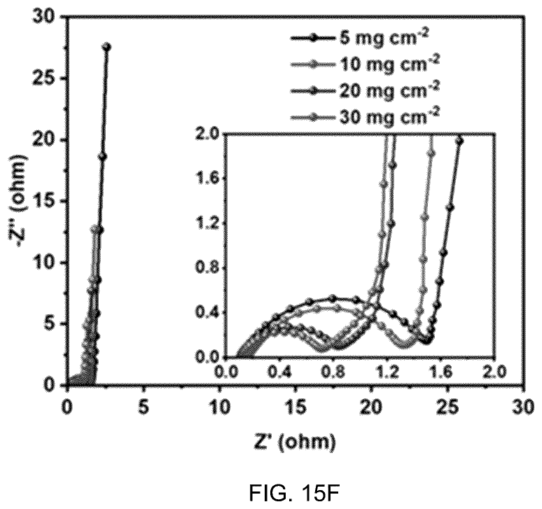

The combination of ultrahigh areal capacitance with an extended working voltage of 1.2 V resulted in ultrahigh areal energy density, up to 0.30 mWh cm⁻² at a power density of 4.4 mW cm⁻² (FIG. 15D). This is significantly higher than previous reports for comparable carbons such as: heteroatom-doped pillared porous carbon (AMJ-3, 0.21 mWh cm⁻² at 1.0 mW cm⁻²), edge-enriched carbon nanofiber fabric (Edge-CNF, 0.1375 mWh cm⁻² at 6.4 mW cm⁻²), and graphene/carbon nanofiber films (NG/CNFs, 0.22 mWh cm⁻² at 1.0 mW cm⁻²).

3DG-900 also has an outstanding gravimetric energy density of ˜10 Wh kg⁻¹ regardless of areal mass loading (FIG. 13G), which is higher than previous reports for high mass loading carbon electrode supercapacitors using aqueous electrolytes. At commercial level mass loadings of 10 mg cm⁻², 3DG-900 also displayed an excellent energy density of 4.5 Wh kg⁻¹ at a power density of 4650 W kg⁻¹, suggesting it is well-suited for high-power supercapacitor application. FIG. 13H shows the excellent cycling stability of 3DG-900 with capacitance retention of approx. 80% after 20,000 cycles at a current density of 4.0 A g⁻¹, highlighting the stability of this material and its potential for use in practical supercapacitor devices. More interestingly, 3DG-900 with higher areal mass loadings exhibited slightly better cycling stability which might be explained by slightly better coulombic efficiency, which is more than 99.8% of 3DG-900 with mass loadings of 20 and 30 mg cm⁻² (FIG. 15E).

Synthesis of ECM with Recycled Potassium Carbonate

Synthesizing 3DG-900 on a large scale could present challenges due to the material, processing, and waste costs associated with using large amounts of K₂CO₃ as a catalyst and activating agent. It is however feasible to recycle and recover the K₂CO₃ from the rinse water in the invented process to improve the cost-effectiveness and sustainability of the synthesis process described herein.

Specifically, a small quantity of K₂CO₃ is consumed during the activation redox reaction with CTP at above 600° C. and converted to K and CO (gas):

K₂CO₃+2C→2K+3CO EQUATION 1

Partial decomposition of K₂CO₃ also occurs above 800° C. during the graphenization process to form K₂O and CO₂ (gas):

K₂CO₃→K₂O+CO₂ EQUATION 2

The K and K₂O byproducts from these steps are both converted into KOH during the water rinsing step:

2K+2H₂O→2KOH+H₂ EQUATION 3

K₂O+H₂O→2KOH EQUATION 4

It is therefore possible to recycle the K₂CO₃ and KOH salt mixture in the rinse water by neutralizing the KOH byproduct with KHCO₃ and drying the rinse water to recover K₂CO₃ as a solid salt that can be re-used in subsequent graphenization cycles:

KOH+KHCO₃→K₂CO₃+H₂O EQUATION 5

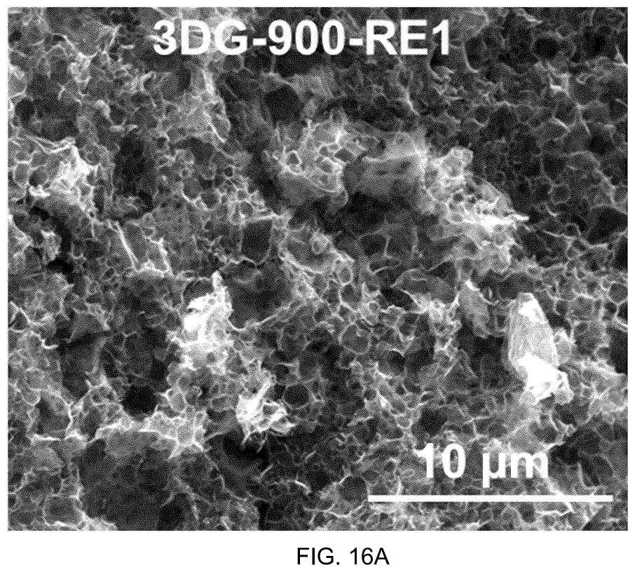

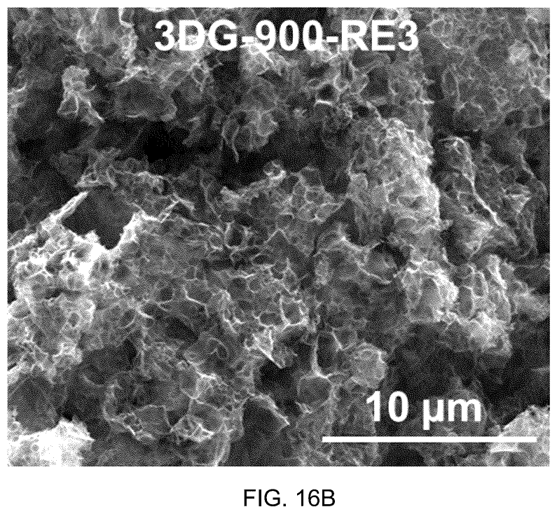

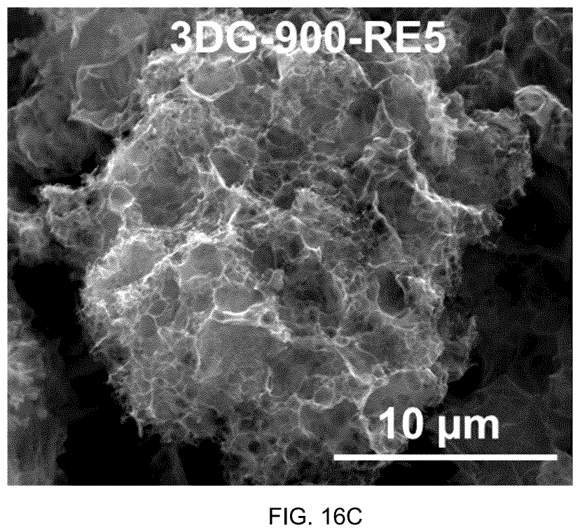

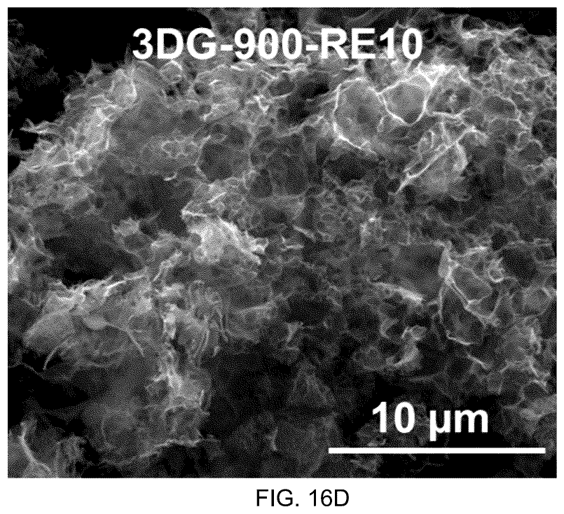

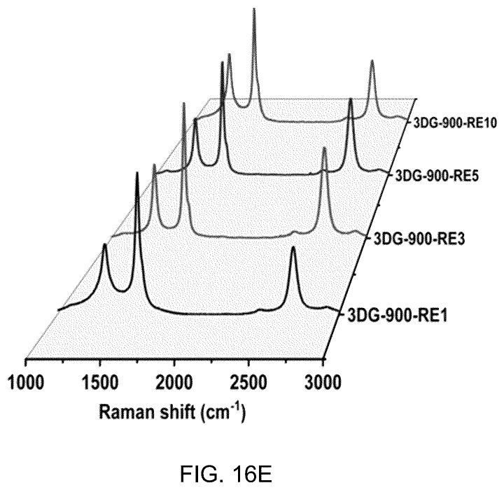

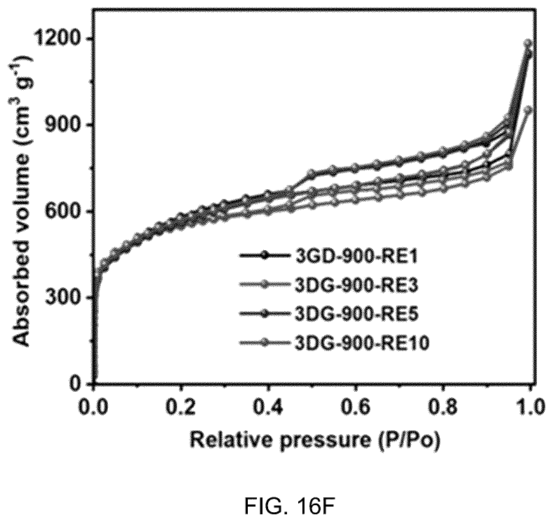

The detailed steps involved in the recycling and recovery process are described below. FIGS. 16A-16F shows representative SEM, Raman and N₂ isotherms of 3D graphenes synthesized with recycled K₂CO₃ at the graphenization temperature of 900° C., denoted as 3DG-900-REx, where x is the number of times the K₂CO₃ has been recycled. FIGS. 16A-16D for 3DG-900-REx show the same hierarchical, interconnected, 3D networks of thin, crumpled, graphene sheets and overall macro- and meso-scale pore structures as observed in FIGS. 4A-4B for samples made with fresh K₂CO₃. The Raman spectra of 3DG-900-REx also exhibited prominent D, G and 2D bands with I_{D}/I_{G} in the range of 0.50-0.57, slightly lower than that of 3DG-900. The N₂ isotherms of 3DG-900-REx showed similarly patterned curves with BET SSA of 2000-2080 m² g⁻¹ and total pore volumes of 1.47-1.83 cm³ g⁻¹, which is only slightly lower than that of 3DG-900. Moreover, the C/O ratio of 3DG-900-REx determined by XPS ranged from 47.8 to 57.8, slightly higher than 3DG-900. It is interesting to note that the slightly lower textural properties of 3DG-900-REx may be a result of a higher degree of graphenization as evidenced by the slightly lower Raman I_{D}/I_{G} and higher C/O ratio.

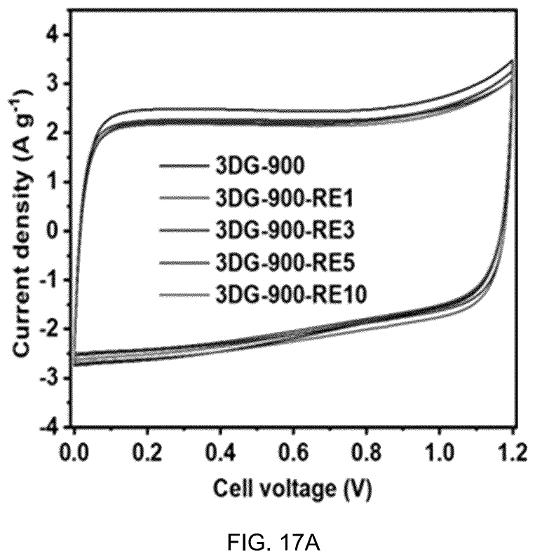

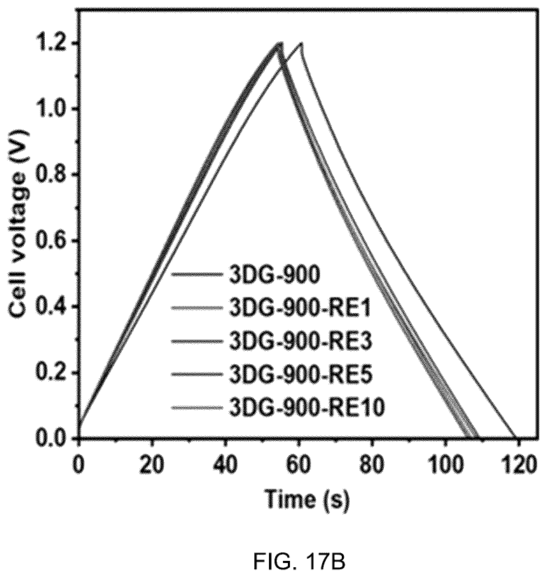

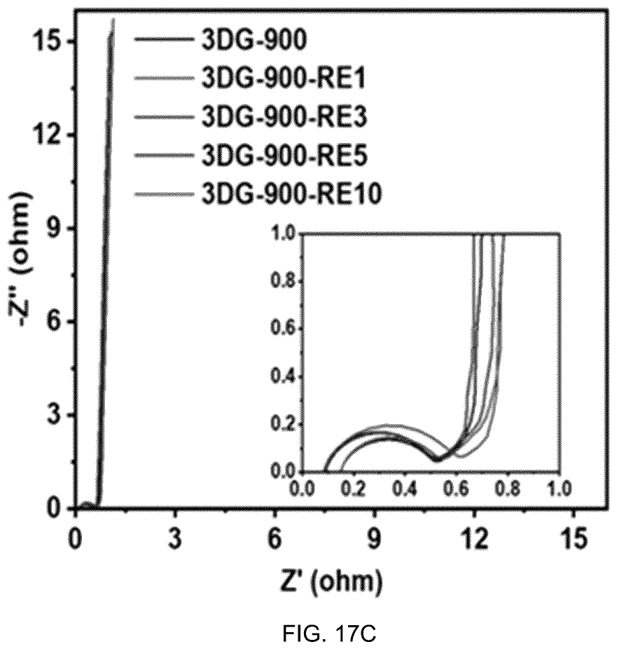

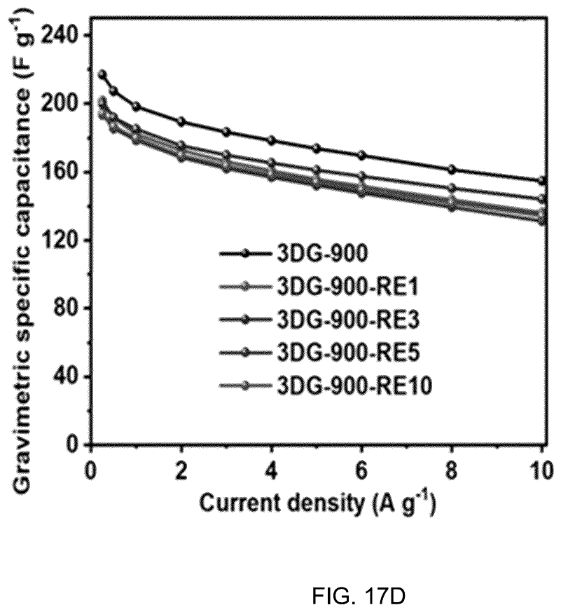

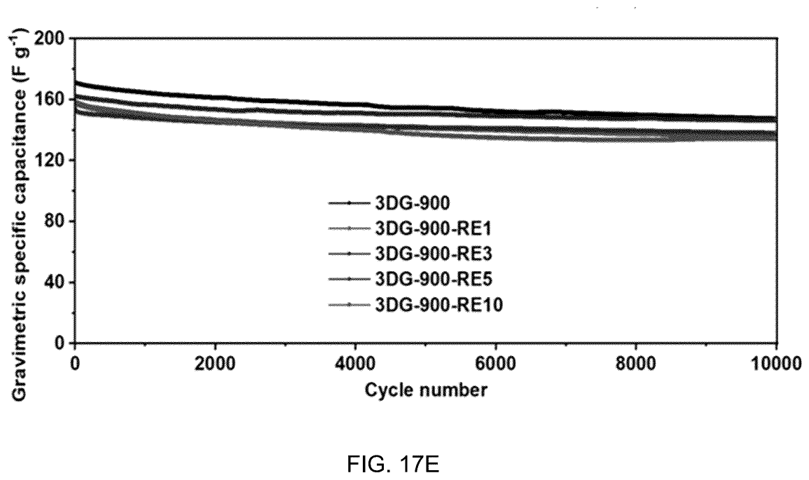

The electrochemical capacitive properties of 3DG-900-REx supercapacitors with commercial level areal mass loading were shown together with 3DG-900 in FIGS. 17A-17E. The CVs of 3DG-900-REx displayed nearly rectangular shape, almost identical to 3DG-900 but somewhat smaller response current densities, implying slightly smaller specific capacitances. The GCD curves of 3DG-900-REx were also symmetrically triangular with very small IR drops, similar to 3DG-900 but with slightly slower response time. The Nyquist plots (FIG. 17C) of 3DG-900-REx were identical to 3DG-900 with very small semicircle in the high-frequency region and a nearly vertical line in the low-frequency region, indicating the nearly ideal capacitive behavior. The close-up inset shows the ESR of 3DG-900-REx and 3DG-900 were very similar, in the range of only 0.65 to 0.75 ohm. FIG. 17D shows the specific capacitance of 3DG-900-REx to be approx. 195-200 F g⁻¹ at a current density of 0.25 A g⁻¹, in comparison to 215 F g⁻¹ measured for 3DG-900. The slightly smaller specific capacitance of 3DG-900-REx could be attributed to their slightly lower BET SSA. The cycling stability of 3DG-900-REx were similar to that of 3DG-900, about 85-90% capacitance retention after 10,000 cycles.

Overall, 3DG-900-REx shows consistency in physical and electrochemical capacitive properties over 10 cycles, suggesting it is possible to recycle the K₂CO₃ further. This appears to be the first and only report on recycling the K₂CO₃ activation agent which is commonly used for converting carbon feedstocks into graphene and porous carbons.

### Discussion

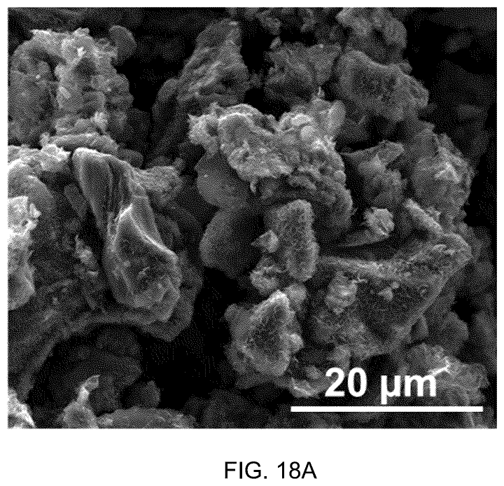

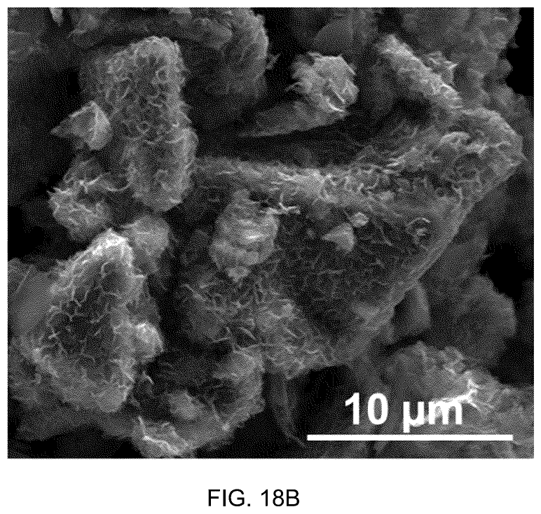

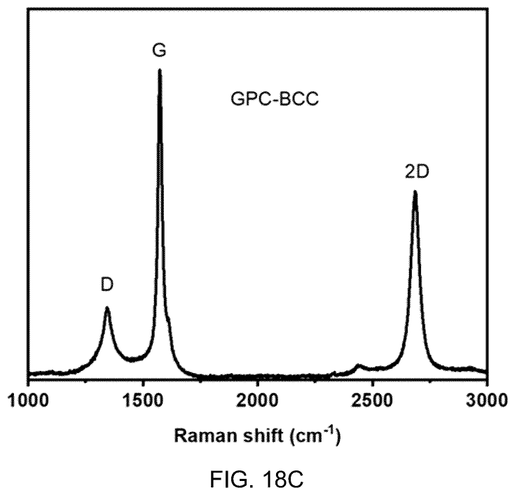

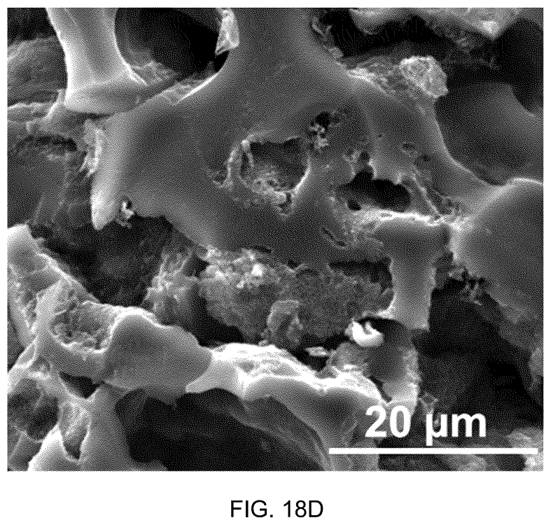

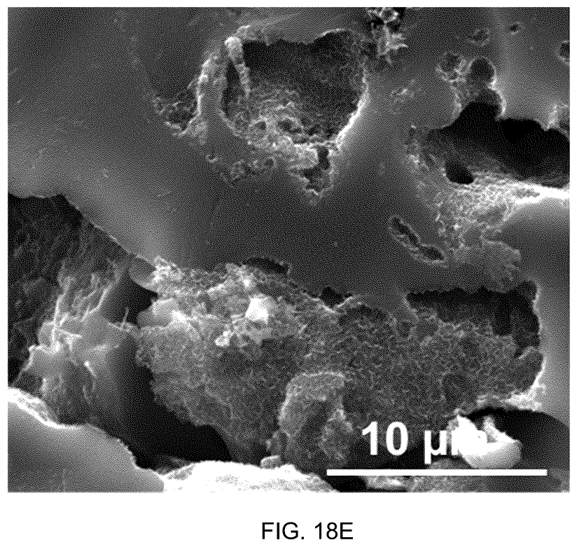

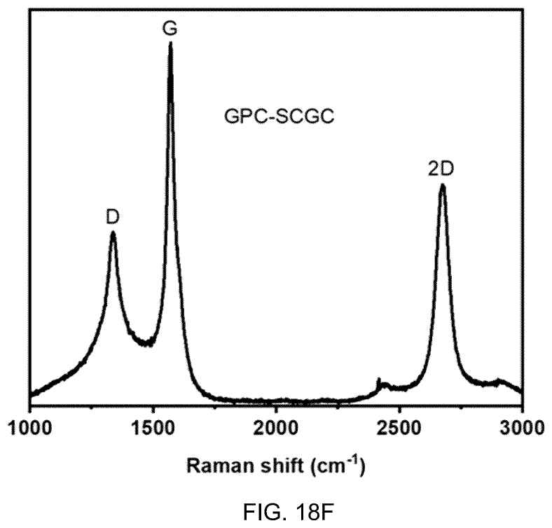

The 3DG samples were synthesized using K₂CO₃ and CTP which are a common activating agent and carbon feedstock, respectively, for the synthesis of amorphous porous carbons. The graphenization activity of K₂CO₃ was not recognized until the reporting of the formation of 3D porous graphene-like sheets (3DPGLS) by thermal treatment of coconut shell char with K₂CO₃ at 900° C. It was found that the synthesis method and use of solid carbon feedstocks previously reported only results in the graphenization on the surface of the carbon particle. The present results with solid bituminous coal char (BCC) and a solid porous spent coffee ground char (SCGC) feedstocks (FIGS. 18A-18C) show that only the surface region of the carbon particle is graphenized leaving an amorphous carbon core in the sample. The results are consistent with the Raman mapping reported in the literature on samples flattened by glass slides that show regions in their sample with high graphenization, as well as regions of amorphous carbon with low- or no-graphenization. It is believed that the surface restricted graphenization reaction of K₂CO₃ is a fundamental characteristic of using larger particles of solid carbon feedstock with the precise synthesis method reported in the literature due to the limited contact between solid carbon feedstock with the K₂CO₃ catalyst.

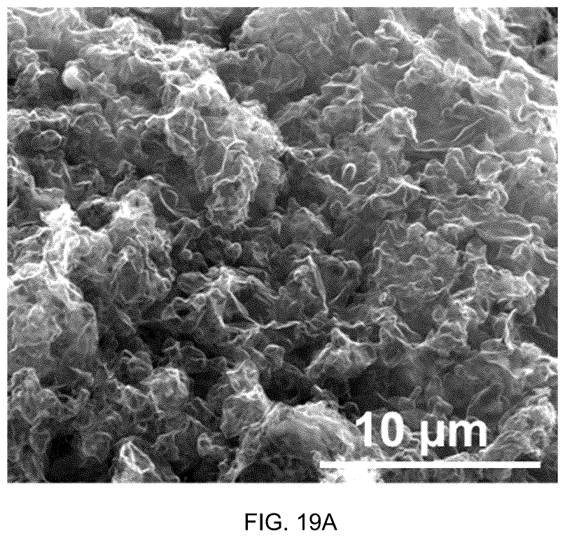

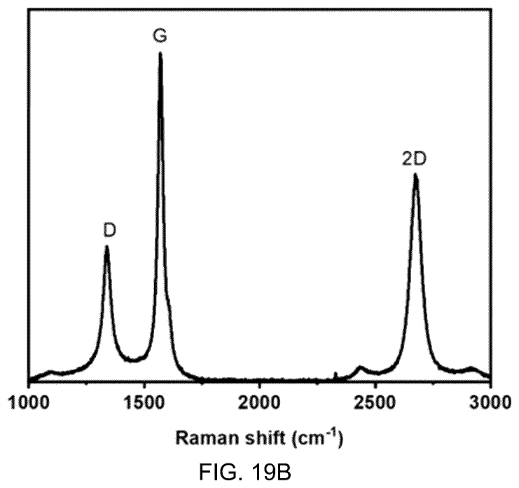

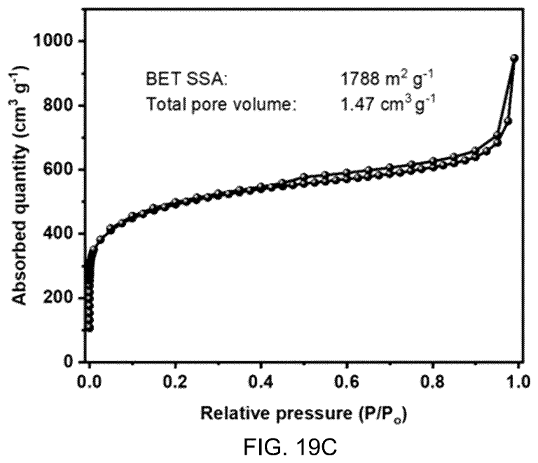

This invention addresses this challenge by using a CTP feedstock with a high ratio of K₂CO₃ to carbon. CTP, unlike solid carbon, melts upon heating and coats the surface of K₂CO₃ particles, as well as the spaces between these particles. The high K₂CO₃ to carbon ratio ensures that the melted CTP is then carbonized into a 3D network of very thin carbon nanosheets which allow direct, intimate contact between the catalyst and carbon precursor. The carbon nanosheets are subsequently graphenized above the melting point of K₂CO₃ into graphene sheets. The invented process also works with petroleum pitch (FIGS. 19A-19C). The use of carbon pitch feedstocks as well as the high K₂CO₃ to carbon ratio are unique facets of the present invention that have not been explored in previous literature and that result in the quality and electrocapacitive performance of 3DG samples reported herein.

The synthesis method reported here uses inexpensive, commercially available, reagents (K₂CO₃ and pitch) along with simple thermal processing under an inert atmosphere to produce a high surface area, conductive carbon that possesses remarkable supercapacitor performance properties at a commercial level mass loading and thickness. The carbon material produced in this work performs significantly better across nearly all electrocapacitive performance metrics than previously reported literature. The simple synthesis method and unique electrocapacitive properties at commercial level mass loadings and thickness make the results described herein highly relevant for the production and engineering of practical supercapacitor devices. Moreover, the high specific surface area (˜2100 m² g⁻¹), high pore volume (˜1.8 cm³ g¹), superior electrical conductivity and 3D interconnected hierarchical micro/meso/macroporous structure, make 3DG-900 a promising electrode material for other electrochemical applications such as cathode hosts for lithium-sulfur batteries and zinc-iodine batteries, cathode materials for hybrid capacitors and electrochemical catalyst supports.

In summary, this invention provides a facile method to synthesize high-quality microscopic 3D graphenes with BET SSA up to 2100 m² g⁻¹, the highest value reported for 3D graphene, which exhibited outstanding electrochemical capacitive properties with ultrahigh areal capacitance more than 6 F cm⁻², excellent energy density of more than 10 Wh kg⁻¹ and superior cycling stability of ˜80% capacitance retention after 20,000 cycles with extended working voltage of 1.2 V with 6M KOH electrolyte. More importantly, for the first time in literature, the process to recycling template and catalyst agent for graphene synthesis for at least 10 cycles was demonstrated, resulting in low-cost and sustainable production. The achievement of facile, low-cost, and sustainable production of such high-quality graphene with outstanding capacitive properties at ultra-high mass loading would open up exciting opportunities for the application of graphene in supercapacitors at commercial scale.

### Synthesis of 3D Graphenes

3D graphene was synthesized by ball-milling of 2.0 g coal tar pitch with 20.0 g K₂CO₃ (mass ratio of 1:10) for 15 min, followed by heating to 600° C. at a ramping rate of 10° C. min 1 for 2.0 hours for carbonization and then continue heating to 900 and 950° C. for 2.0 hours or 1000° C. for 1 hour for catalytic graphenization under a nitrogen atmosphere. After natural cooling, obtained sample was washed twice with DI water by adding sample into 150 mL water, mixed and heated to 80° C. for 1 hour, subsequently suction filtrated. The attained filtered cake was washed with 1.0 M hydrochloric acid solution (80° C., 2 hours) and then with DI water until neutral pH and finally dried at 150° C. for 5 hours. The obtained 3D graphene samples were denoted as 3DG-x where x is graphenization temperature.

The recycling of K₂CO₃ was carried by collecting filtrates in the first two washes with DI water, neutralizing with 1.0 g potassium bicarbonate (KHCO₃) and drying at 200° C. for 6 hours. The obtained recycled K₂CO₃ (˜20.0 g) was ground and then ball-milled with 2.0 g coal tar pitch, followed by pre-carbonization, catalytic graphenization and washing with the same procedures as described above. The obtained 3D graphene samples were denoted as 3DG-x-REy where x and y are graphenization temperature and recycle time, respectively.

### Materials Characterization

Scanning electron microscopy (SEM) imaging was carried out on a FEI Quanta 600F microscope operated at 10-20 kV equipped with an energy-dispersive X-ray (EDX) detector. High-resolution transmission electron microscopy (HR-TEM) was performed on a FEI Titan Themis G2 200 Probe Cs Corrected Scanning Transmission Electron Microscope operated at accelerating voltage of 200 kV. Raman spectroscopy was conducted on a LabRam HR-Evolution spectrometer (Horiba Scientific) with a 532 nm laser as an excitation source. X-ray photoelectron spectroscopy (XPS) was carried out on a PHI 5000 VersaProbe III scanning XPS microprobe (Physical Electronics, ULVAC-PHI Inc) using Al Kα (1486.6 eV) radiation source and a hemispherical analyzer. X-ray powder diffraction (XRD) patterns were characterized on a PANalytical X'Pert Pro X-ray diffractometer using CuKα radiation (λ=1.5418 Å) at a scan rate of 1.0 degree min⁻¹. N₂ adsorption-desorption isotherms analysis was measured on Quantachrome Autosorb-1 at −196° C. For electrical conductivity measurement, 3DG samples were mixed with polytrafluoroethylene (PTFE, 5 wt. %) in methanol, sonicated for 5 minutes, dried at 120° C. for 3 hours and then compressed into 200 μm pellet using FTIR sampling kit under compression force of 4.0 tons cm⁻² for 30 seconds. The sheet resistance of 3DG pellets were measured on a four-point probe Jandel RM3-AR and electrical conductivity (σ (S m⁻¹)) of 3DG pellets were calculated by σ=1/Rₛt where Rₛ is sheet resistance (Ω) and t is pellet thickness (m).

### Electrode Fabrication and Electrochemical Performance Characterization

3DG-900 electrodes were fabricated by mixing 95.0 mg and 5.0 mg PTFE binder in 10 mL methanol alcohol, sonicating for 5 minutes and then dried at 120° C. for 3 hours. The obtained powders were compressed into free-standing electrode pellet (1.3 cm in diameter, corresponding to 1.33 cm² in area) with different mass loadings (5.0, 10.0, 20.0 and 30.0 mg cm⁻²) using FTIR sampling kit with 13 mm pellet die by hydraulic press under compression force of 4.0 tons cm⁻² for 30 seconds. We note it is necessary to compress this material to make a compact and robust electrode, especially at high mass loadings. This compression improves the electrochemical capacitive performance of the 3D graphene reported in this paper. Symmetric supercapacitors with a two-electrode configuration were fabricated using two identical electrodes as both anode and cathode sandwiched between two nickel foam current collectors, a cellulose filter paper (Whatman) as a separator sandwiched between two electrodes, and aqueous solution of 6 M KOH as electrolytes. All the components were assembled into a layered structure and were tightly sealed in a supercapacitor test cell (EQ-STC split flat cell, MTI Corp.). Cyclic voltammetry and galvanostatic charge-discharge measurements were performed on a potentiostat/galvanostat Biologic SP-150. Electrochemical impedance spectroscopy tests were recorded over a frequency range from 0.01 Hz to 200 kHz at an open-circuit potential with an AC perturbation of 10.0 mV. The gravimetric and areal specific capacitance, energy density, and power density were calculated according to the following equations:

$${C}_{g} = 4 ( \frac{I Δ t}{m Δ V )} ) \qquad EQUATION 6$$

$${C}_{a} = \frac{{mC}_{g}}{A} \qquad EQUATION 7$$

$${E}_{g} = \frac{1}{8} {{C}_{g} ( Δ V )}^{2} \qquad EQUATION 8$$

$${P}_{g} = \frac{{E}_{g}}{Δ t} \qquad EQUATION 9$$

Where C_{g} and Cₐ are the gravimetric and areal specific capacitances, E_{g} and P_{g} are the gravimetric energy density and power density, respectively. I is the constant discharge current, Δt is the discharging time, m and A are mass and area of two electrodes, and ΔV is the operating voltage (obtained from the discharge curve subtracted by the voltage drop).

In an embodiment, the invention provides a carbon electrode material (CEM) comprising: a hierarchical, interconnected, 3D network of thin, crumpled, graphene sheets, wherein the graphene sheets comprise irregularly shaped, micro-, meso- and macro-scale pore structures, wherein the CEM comprises a BET SSA between approximately 1400 m² g⁻¹ and approximately 2200 m² g⁻¹, and wherein the CEM comprises a Raman I_{D}/I_{G} intensity ratio between approximately 0.05 to approximately 1.2. In an embodiment, the CEM further comprises a Raman I_{2D}/I_{G} intensity ratio between approximately 0.2 to approximately 0.8. In an embodiment, the CEM further comprises an atomic carbon/oxygen (C/O) ratio between approximately 20 to approximately 100. In an embodiment, the CEM further comprises a total pore volume between approximately 1.5 cm³ g⁻¹ and approximately 2.5 cm³ g⁻¹. In an embodiment, the CEM have a diameter between approximately 0.5 nm and approximately 200 nm. In an embodiment, the CEM further comprises a conductivity between approximately 1000 Sm⁻¹ and approximately 2500 Sm⁻¹. In an embodiment, the CEM further comprises a conductivity of at least 1000 Sm⁻¹. In an embodiment, the CEM is configured to have a conductivity of at least 1000 Sm⁻¹ when an electrical current is applied to the CEM.

In an embodiment, the invention provides a supercapacitor comprising: a first electrode, a second electrode, a porous separator positioned between the first and second electrodes, and an electrolyte in electronic and physical contact with the first and second electrodes and the porous separator, wherein at least one of the first and second electrodes comprise a carbon electrode material (CEM), the CEM comprising: a hierarchical, interconnected, 3D network of thin, crumpled, graphene sheets, wherein the graphene sheets comprise irregularly shaped, micro-, meso- and macro-scale pore structures, wherein the CEM comprises a BET SSA between approximately 1400 m² g⁻¹ and approximately 2200 m² g⁻¹, and wherein the CEM comprises a Raman I_{D}/I_{G} intensity ratio between approximately 0.05 to approximately 1.2. In an embodiment, the CEM further comprises a Raman I_{2D}/I_{G} intensity ratio between approximately 0.2 to approximately 0.8. In an embodiment, the CEM further comprises an atomic carbon/oxygen (C/O) ratio between approximately 20 to approximately 100.

The supercapacitor of claim 9 wherein the CEM further comprises a total pore volume between approximately 1.5 cm³ g⁻¹ and approximately 2.5 cm³ g⁻¹. In an embodiment, the pores have a diameter between approximately 0.5 nm and approximately 200 nm. In an embodiment, the CEM further comprises a conductivity between approximately 1000 Sm⁻¹ and approximately 2500 Sm⁻¹. In an embodiment, the CEM further comprises a conductivity of at least 1000 Sm⁻¹. In an embodiment, the supercapacitor further comprises a maximum gravimetric energy density at current density of 1.0 A/g between approximately 8.0 Wh kg⁻¹ and approximately 20.0 Wh kg⁻¹. In an embodiment, the supercapacitor further comprises a gravimetric specific capacitance between approximately 150 F/g and approximately 250 F/g per gram CEM at a current density of 1.0 A/g of CEM. In an embodiment, the supercapacitor further comprises a gravimetric specific capacitance of at least 150 F/g of CEM at a current density of 1.0 A/g of CEM.

In an embodiment, the invention provides a method for making carbon electrode material (CEM) comprising: a) dispersing a carbon feedstock within a catalyst, thereby forming a mixture, wherein the catalyst comprises particles; b) melting the carbon feedstock that is dispersed within the catalyst, thereby liquifying the carbon feedstock, wherein the liquified carbon feedstock coats catalyst particles and infiltrates spaces between said catalyst particles; c) carbonizing the melted carbon feedstock, thereby forming an interconnected 3D network of carbon nanosheets; d) converting the carbon nanosheets into graphene nanosheets; e) washing the graphene nanosheets, thereby forming the CEM; and f) recovering and regenerating the catalyst. In an embodiment, the carbon feedstock is a pitch-based carbon-containing material, and the CEM comprises a hierarchical, interconnected, 3D network of thin, crumpled, graphene sheets, wherein the graphene sheets comprise irregularly shaped, micro-, macro-, and meso-scale pore structures. In an embodiment, the carbon feedstock is selected from the group consisting of coal tar pitch, petroleum pitch, and combinations thereof. In an embodiment, the catalyst comprises a carbonate selected from the group consisting of K₂CO₃, Na₂CO₃, Li₂CO₃, KHCO₃, NaHCO₃, LiHCO₃, and combinations thereof. In an embodiment, the method further comprises repeating steps a)-e) using recovered and regenerated catalyst. In an embodiment, the mixture has a wt:wt ratio of carbon feedstock to catalyst between approximately 1:5 to approximately 1:20. In an embodiment, the converting the carbon nanosheets into graphene nanosheets step is performed at a temperature between approximately 900° C. and approximately 1100° C., and wherein said temperature is above the melting point of the catalyst. In an embodiment, washing the graphene nanosheet forms an eluent containing K₂CO₃ and KOH, and recovering and regenerating the catalyst comprises adding KHCO₃ to the eluent, and drying the eluent to form regenerated catalyst. In an embodiment, CEM made using recovered and regenerated catalyst is identical to CEM made using fresh catalyst. In an embodiment, the CEM further comprises a BET SSA between approximately 1400 m² g⁻¹ and approximately 2200 m² g⁻¹, and wherein the CEM comprises a Raman I_{D}/I_{G} intensity ratio between approximately 0.05 to approximately 1.2. In an embodiment, the CEM further comprises a Raman I_{2D}/I_{G} intensity ratio between approximately 0.2 to approximately 0.8. In an embodiment, the CEM further comprises an atomic carbon/oxygen (C/O) ratio between approximately 20 to approximately 100. In an embodiment, the CEM further comprises a total pore volume between approximately 1.5 cm³ g⁻¹ and approximately 2.5 cm³ g⁻¹. In an embodiment, the CEM further comprises pores having a diameter between approximately 0.5 nm and approximately 200 nm. In an embodiment, the CEM further comprises a conductivity between approximately 1000 Sm⁻¹ and approximately 2500 Sm⁻¹. In an embodiment, the CEM further comprises a conductivity of at least 1000 Sm⁻¹. In an embodiment, the catalyst comprises a carbonate selected from the group consisting of KHCO₃, NaHCO₃, LiHCO₃, and combinations thereof.

Having described the basic concept of the embodiments, it will be apparent to those skilled in the art that the foregoing detailed disclosure is intended to be presented by way of example. Accordingly, these terms should be interpreted as indicating that insubstantial or inconsequential modifications or alterations and various improvements of the subject matter described and claimed are considered to be within the scope of the spirited embodiments as recited in the appended claims. Additionally, the recited order of the elements or sequences, or the use of numbers, letters or other designations therefor, is not intended to limit the claimed processes to any order except as may be specified. All ranges disclosed herein also encompass any and all possible sub-ranges and combinations of sub-ranges thereof. Any listed range is easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as up to, at least, greater than, less than, and the like refer to ranges which are subsequently broken down into sub-ranges as discussed above. As utilized herein, the terms “about,” “substantially,” and other similar terms are intended to have a broad meaning in conjunction with the common and accepted usage by those having ordinary skill in the art to which the subject matter of this disclosure pertains. As utilized herein, the term “approximately equal to” shall carry the meaning of being within 15, 10, 5, 4, 3, 2, or 1 percent of the subject measurement, item, unit, or concentration, with preference given to the percent variance. It should be understood by those of skill in the art who review this disclosure that these terms are intended to allow a description of certain features described and claimed without restricting the scope of these features to the exact numerical ranges provided. Accordingly, the embodiments are limited only by the following claims and equivalents thereto. All publications and patent documents cited in this application are incorporated by reference in their entirety for all purposes to the same extent as if each individual publication or patent document were so individually denoted.

All numeric values are herein assumed to be modified by the terms “about” or “approximately,” whether or not explicitly indicated. The terms “about” or “approximately” generally refer to a range of numbers that one of skill in the art would consider equivalent to the recited value (e.g., having the same function or result). In many instances, the terms “about” and “about” include numbers that are rounded to the nearest significant figure.

The recitation of numerical ranges by endpoints includes all numbers within that range (e.g. 1 to 5 includes 1, 1.5, 2, 2.75, 3, 3.80, 4, and 5).

One skilled in the art will also readily recognize that where members are grouped together in a common manner, such as in a Markush group, the present invention encompasses not only the entire group listed as a whole, but each member of the group individually and all possible subgroups of the main group. Accordingly, for all purposes, the present invention encompasses not only the main group, but also the main group absent one or more of the group members. The present invention also envisages the explicit exclusion of one or more of any of the group members in the claimed invention.

What is claimed is:

1. A method for making carbon electrode material (CEM) comprising:
a. dispersing a carbon feedstock within a catalyst, thereby forming a mixture, wherein the catalyst comprises particles;
b. melting the carbon feedstock that is dispersed within the catalyst, thereby liquifying the carbon feedstock, wherein the liquified carbon feedstock coats catalyst particles and infiltrates spaces between said catalyst particles;
c. carbonizing the melted carbon feedstock, thereby forming an interconnected 3D network of carbon nanosheets;
d. converting the carbon nanosheets into graphene nanosheets;
e. washing the graphene nanosheets, thereby forming the CEM; and
f. recovering and regenerating the catalyst.

2. The method of claim 1 wherein the carbon feedstock is a pitch-based carbon-containing material, and wherein the CEM comprises a hierarchical, interconnected, 3D network of thin, crumpled, graphene sheets, wherein the graphene sheets comprise irregularly shaped, micro-, macro-, and meso-scale pore structures.

3. The method of claim 2 wherein the carbon feedstock is selected from the group consisting of coal tar pitch, petroleum pitch, and combinations thereof.

4. The method of claim 2 wherein the catalyst comprises a carbonate selected from the group consisting of K₂CO₃, Na₂CO₃, Li₂CO₃, KHCO₃, NaHCO₃, LiHCO₃, and combinations thereof.

5. The method of claim 3 further comprising repeating steps a.-e. using recovered and regenerated catalyst.

6. The method of claim 2 wherein the mixture has a wt:wt ratio of carbon feedstock to catalyst between approximately 1:5 to approximately 1:20.

7. The method of claim 2 wherein the converting the carbon nanosheets into graphene nanosheets step is performed at a temperature between approximately 900° C. and approximately 1100° C., and wherein said temperature is above the melting point of the catalyst.

8. The method of claim 3 wherein washing the graphene nanosheet forms an eluent containing K₂CO₃ and KOH, and recovering and regenerating the catalyst comprises adding KHCO₃ to the eluent, and drying the eluent to form regenerated catalyst.

9. The method of claim 4 wherein CEM made using recovered and regenerated catalyst is identical to CEM made using fresh catalyst.

10. The method of claim 4 wherein the CEM further comprises a BET SSA between approximately 1400 m² g⁻¹ and approximately 2200 m² g⁻¹, and wherein the CEM comprises a Raman I_{D}/I_{G} intensity ratio between approximately 0.05 to approximately 1.2.

11. The method of claim 9 wherein the CEM further comprises a Raman I_{2D}/I_{G} intensity ratio between approximately 0.2 to approximately 0.8.

12. The method of claim 9 wherein the CEM further comprises an atomic carbon/oxygen (C/O) ratio between approximately 20 to approximately 100.

13. The method of claim 9 wherein the CEM further comprises a total pore volume between approximately 1.5 cm³ g⁻¹ and approximately 2.5 cm³ g⁻¹.

14. The method of claim 9 wherein the CEM further comprises pores having a diameter between approximately 0.5 nm and approximately 200 nm.

15. The method of claim 9 wherein the CEM further comprises a conductivity between approximately 1000 Sm⁻¹ and approximately 2500 Sm⁻¹.

16. The method of claim 9 wherein the CEM further comprises a conductivity of at least 1000 Sm⁻¹.

17. The method of claim 2 wherein the catalyst comprises a carbonate selected from the group consisting of KHCO₃, NaHCO₃, LiHCO₃, and combinations thereof.
